(19) United States
(12) Patent Application Publication
(10) Pub. No.: US 2023/0156647 A1
(43) Pub. Date: May 18, 2023

(54) 5G SMALL CELL TIME SYNCHRONIZED NETWORKING

(71) Applicant: Casa Systems, Inc., Andover, MA (US)

(72) Inventors: Óscar Carrasco Quilis, Valencia (ES); Faiza Bouchmal, Valencia (ES)

(73) Assignee: Casa Systems, Inc., Andover, MA (US)

(21) Appl. No.: 17/985,062

(22) Filed: Nov. 10, 2022

Related U.S. Application Data
(60) Provisional application No. 63/278,781, filed on Nov. 12, 2021.

(51) Int. Cl. H04W 56/00

(52) U.S. Cl. CPC H04W 56/0045

(57) ABSTRACT

The techniques described herein relate to methods, apparatuses and computer readable media configured to provide a computerized method to provide Time-Sensitive Networking over a wireless channel of a cellular network. The method includes receiving, by the network device, timing information from a cellular network node. When the timing information is received, determining, by the network device, a timing adjustment based on the timing information. The timing adjustment is used to adjust a timing signal that is transmitted by the network device to a user device in cellular communication with the cellular network node through the network device, wherein the timing signal is used to adjust a timing of the user device in accordance with the synchronization protocol.

### RELATED APPLICATIONS

This application claims priority under 35 U.S.C. § 119(e) to U.S. Provisional Application Ser. No. 63/278,781, titled “5G SMALL CELL TIME SYNCHRONIZED NETWORKING,” filed on Nov. 12, 2021, which is hereby incorporated by reference herein in its entirety.

### FIELD

The techniques described herein relate generally to a time synchronized network, such as a 5G small cell time synchronized network.

### BACKGROUND

A time synchronized network can provide a framework for coordinating a common time amongst different applications, different instances of an application, and/or different devices connected to the network. The common time coordinated among the different applications and/or devices using the time synchronized network can enable scheduling of actions, traffic, etc. across the different applications and devices to provide for a coordinated operation (e.g., so that the applications may operate in unison).

### SUMMARY OF THE DISCLOSURE

In accordance with the disclosed subject matter, apparatus, systems, and methods are provided for a Time-Sensitive Networking synchronization protocol over a wireless channel of a cellular network.

Some embodiments relate to a computerized method to provide a Time-Sensitive Networking (TSN) synchronization protocol over a wireless channel of a cellular network. The method comprises performing, by a cellular network device: receiving, by the network device, timing information from a cellular network node, wherein the cellular network node is in wired communication with the network device, and the timing information is associated with a Network Clock Reference and a transmission time to the network device in accordance with a wired synchronization protocol; determining, by the network device, a timing adjustment based on the timing information; and adjusting, based on the timing adjustment, timing signals that are transmitted by the network device to a user device in cellular communication with the cellular network node through the network device, wherein the timing signals is used to adjust a timing system of the user device in accordance with the TSN synchronization protocol.

In some examples, the TSN synchronization protocol is a wireless synchronization protocol, and the wireless synchronization protocol comprises: transmitting, by the network device, downlink information of a radio frame, wherein the transmitting the downlink information comprises transmitting a pattern of reference synchronization signals as the timing signals to the user device; receiving, by the network device, uplink information of the radio frame, wherein the uplink information comprises response information corresponding to a time of arrival of the downlink information at the user device; and determining, by the network device, delay information associated with a travel time for the radio frame to wirelessly travel from the network device to the user device, wherein determining the delay information comprises comparing a first time associated with the network device transmitting the downlink information, to a second time associated with the network device receiving the uplink information.

In some examples, the receiving, by the network device, the uplink information further comprises using a Random-Access procedure between the network device and the user device, and the determining the delay information further comprises determining a timing advance.

In some examples, the radio frame comprises a plurality of subframes, wherein each of the plurality of subframes comprises a plurality of slots, wherein each of the plurality of slots comprises a plurality of symbols; and the transmitting the pattern of reference synchronization signals further comprises transmitting the pattern of reference synchronization signals as a sub-set of the plurality of symbols.

In some examples, the determining the timing adjustment further comprises: determining a synchronized time based on the timing information and the delay information; determining a target arrival time for a portion of the radio frame based on the synchronized time; and determining the timing adjustment based on the target arrival time, the timing information, and the delay information such that, when transmitted, the portion of the radio frame arrives at the user device at the target arrival time.

In some examples, the portion of the radio frame is a first slot of a first subframe of the radio frame, and the target arrival time that the radio frame arrives at the user device is at the start of a synchronized clock interval.

In some examples, the TSN synchronization protocol supports TSN in accordance with IEEE 802.1AS standard, the TSN synchronization protocol further comprising transmitting, by the network device, the synchronized time such that when the synchronized time arrives at the user device, the synchronized time is synchronized to within a predetermined threshold of a reference time.

In some examples, the predetermined threshold is within 1 nanosecond of the reference time, within 1 microsecond of the reference time, or some combination thereof.

In some examples, the predetermined threshold is within 250 nanoseconds of the reference time in dispersive channels with time-variant conditions.

In some examples, transmitting the pattern of reference synchronization signals further comprises transmitting a radio frame using subcarrier bandwidths from 15 kHz to 240 kHz.

In some examples, the receiving timing information from the cellular network comprises receiving a reference time, residence time, and link delay from the reference clock to the network node based on a generic Precision Time Protocol (g-PTP) of the cellular network.

In some examples, the network device is a base station.

In some examples, the base station is a gNodeB and the cellular network is a 5G network.

Some embodiments related to an apparatus configured to provide a TSN synchronization protocol over a wireless channel of a cellular network, the apparatus comprising a processor in communication with memory and a set of additional processing resources, the processor being configured to execute instructions stored in the memory that cause the processor to: receive, by the network device, timing information from a cellular network node, wherein the cellular network node is in wired communication with the network device, and the timing information is associated with a Network Clock Reference and a transmission time to the network device in accordance with a wired synchronization protocol; determine, by the network device, a timing adjustment based on the timing information; and adjust, based on the timing adjustment, timing signals that is transmitted by the network device to a user device in cellular communication with the cellular network node through the network device, wherein the timing signals is used to adjust a timing system of the user device in accordance with the TSN synchronization protocol.

In some examples, the TSN synchronization protocol is a wireless synchronization protocol, and wherein the instructions are further configured in accordance with the TSN synchronization protocol to cause the apparatus to: transmit, by the network device, downlink information of a radio frame, wherein the transmitting the downlink information comprises transmitting a pattern of reference synchronization signals as the timing signals to the user device; receive, by the network device, uplink information of the radio frame, wherein the uplink information comprises response information corresponding to a time of arrival of the downlink information at the user device; and determine, by the network device, delay information associated with a travel time for the radio frame to wirelessly travel from the network device to the user device, wherein determining the delay information comprises comparing a first time associated with the network device transmitting the downlink information, to a second time associated with the network device receiving the uplink information.

In some examples, the instructions are configured such that the radio frame comprises a plurality of subframes, wherein each of the plurality of subframes comprises a plurality of slots, wherein each of the plurality of slots comprises a plurality of symbols; and the instructions are further configured to cause the apparatus to transmit the pattern of reference synchronization signals further comprises transmitting the pattern of reference synchronization signals as a sub-set of the plurality of symbols.

In some examples, the instructions to cause the apparatus to determine the timing adjustment are further configured to: determine a synchronized time based on the timing information, and the delay information; determine a target arrival time for a portion of the radio frame based on the synchronized time; and determine the timing adjustment based on the target arrival time, the timing information, and the delay information such that, when transmitted, the portion of the radio frame arrives at the user device at the target arrival time.

In some examples, the instructions are further configured to execute actions sent from the cellular network that are time-synchronized with at least one user device action through a communication protocol that specifies an action type to be executed and the time when the action shall be executed.

Some embodiments related to at least one non-transitory computer-readable storage medium encoded with a plurality of computer-executable instructions that, when executed, perform a method to provide a TSN synchronization protocol over a wireless channel of a cellular network, the method comprising: receiving, by the network device, timing information from a cellular network node, wherein the cellular network node is in wired communication with the network device, and the timing information is associated with a Network Clock Reference and a transmission time to the network device in accordance with a wired synchronization protocol; determining, by the network device, a timing adjustment based on the timing information; and adjusting, based on the timing adjustment, timing signals that are transmitted by the network device to a user device in cellular communication with the cellular network node through the network device, wherein the timing signals is used to adjust a timing system of the user device in accordance with the TSN synchronization protocol.

In some examples, the synchronization protocol is a wireless synchronization protocol, and the wireless synchronization protocol comprises: transmitting, by the network device, downlink information of a radio frame, wherein the transmitting the downlink information comprises transmitting a pattern of reference synchronization signals as the timing signals to the user device; receiving, by the network device, uplink information of the radio frame, wherein the uplink information comprises response information corresponding to a time of arrival of the downlink information at the user device; and determining, by the network device, delay information associated with a travel time for the radio frame to wirelessly travel from the network device to the user device, wherein determining the delay information comprises comparing a first time associated with the network device transmitting the downlink information, to a second time associated with the network device receiving the uplink information.

In some examples, the determining the timing adjustment further comprises: determining a synchronized time based on the timing information and the delay information; determining a target arrival time for a portion of the radio frame based on the synchronized time; and determining the timing adjustment based on the target arrival time, the timing information, and the delay information such that, when transmitted, the portion of the radio frame arrives at the user device at the target arrival time.

Some embodiments relate to an apparatus configured to receive a synchronization protocol over a wireless channel of a cellular network, the apparatus comprising a processor in communication with memory and a set of additional processing resources, the processor being configured to execute instructions stored in the memory that cause the processor to: receive, by a user device, timing information from a network device, wherein: receiving, by the user device, comprises receiving downlink information of a radio frame, wherein the downlink information comprises frequency and phase synchronization signals configured as timing signals to the user device; the user device extracts, from a 5GNR Radio Resource Control System Information Block 9, a Timing Advance MAC control element and a time reference of the network device to adjust and discipline using the frequency and phase synchronization signals; the user device extracts a physical layer signal from a Slot Indication signal associated with the radio frame and/or a Symbol Boundary signal to adjust and discipline an internal clock of the user device to meet a time accuracy within a Virtual Clock Domain comprising TSN enabled user devices, network devices, network node and TSN controller.

In some examples, the TSN synchronization protocol is a wireless synchronization protocol, and wherein the instructions are further configured in accordance with the TSN synchronization protocol to cause the apparatus to: transmit, by the network device, downlink information of a radio frame, wherein the transmitting the downlink information comprises transmitting a pattern of reference synchronization signals as the timing signals to the user device; receive, by the network device, uplink information of the radio frame, wherein the uplink information comprises response information corresponding to a time of arrival of the downlink information at the user device; and determine, by the network device, delay information associated with a travel time for the radio frame to wirelessly travel from the network device to the user device, wherein determining the delay information comprises comparing a first time associated with the network device transmitting the downlink information, to a second time associated with the network device receiving the uplink information.

In some examples, the instructions are configured such that the radio frame comprises a plurality of subframes, wherein each of the plurality of subframes comprises a plurality of slots, wherein each of the plurality of slots comprises a plurality of symbols; and the instructions are further configured to cause the apparatus to transmit the pattern of reference synchronization signals further comprises transmitting the pattern of reference synchronization signals as a sub-set of the plurality of symbols.

In some examples, the instructions to cause the apparatus to determine the timing adjustment are further configured to: determine a synchronized time based on the timing information, and the delay information; determine a target arrival time for a portion of the radio frame based on the synchronized time; and determine the timing adjustment based on the target arrival time, the timing information, and the delay information such that, when transmitted, the portion of the radio frame arrives at the user device at the target arrival time.

In some examples, the instructions further comprise informing the network device about support of the synchronization protocol and an achievable time accuracy using the instructions that determine the timing adjustment.

In some examples, that include a clock disciplining subsystem to use the physical signals of Slot Indication signals and/or Symbol Boundary signals to discipline the internal clock that translates timing information into a computer-executable instruction that comprises the messages associated with the instructions that determine the timing adjustment.

The foregoing summary is not intended to be limiting. Moreover, various aspects of the present disclosure may be implemented alone or in combination with other aspects.

### BRIEF DESCRIPTION OF FIGURES

In the drawings, each identical or nearly identical component that is illustrated in various figures is represented by a like reference character. For purposes of clarity, not every component may be labeled in every drawing. The drawings are not necessarily drawn to scale, with emphasis instead being placed on illustrating various aspects of the techniques and devices described herein.

FIG. 1 illustrates an exemplary Time Sensitive Networking (TSN) architecture configured with a 5G network and a dedicated TSN network.

FIG. 2A illustrates an exemplary network including a TSN system integrated into the reference 3GPP network architecture.

FIG. 2B illustrates an exemplary network configured for Time Sensitive Communication (TSC) using a small cell with a small cell integrated TSN Translator (SC-TT), in accordance with some embodiments.

FIG. 3 illustrates a private industrial network with a small cell that includes a Small Cell TSN translator, in accordance with some embodiments.

FIG. 4A illustrates a virtual clock domain including network components illustrated in FIG. 3.

FIG. 4B illustrates network including a dedicated virtual TSN slice, in accordance with some embodiments.

FIG. 5A illustrates end-to-end synchronization process, in accordance with some embodiments described herein.

FIG. 5B illustrates an exemplary process of synchronizing the internal clock of the user equipment (UE) with the virtual clock domain, in accordance with some embodiments.

FIG. 5C illustrates a computerized TSN synchronization protocol, in accordance with some embodiments.

FIG. 6A is a schematic of a radio frame that may be used in accordance with the embodiments described herein.

FIG. 6B illustrates a schematic of the timing between the small cell clock flank signal and subframes of the radio frame, in accordance with some embodiments.

FIG. 7 illustrates a process of adjusting the UE timing system based on the timing signal received by the UE, in accordance with some embodiments.

FIG. 8 illustrates a time locked loop feedback circuit, in accordance with some embodiments.

FIG. 9 illustrates an exemplary implementation of TSN network including a 5G small cell and UE, in accordance with some embodiments.

FIG. 10 illustrates an exemplary TSN registration and execution request, in accordance with some embodiments.

FIG. 11 illustrates an exemplary peer-to-peer TSN protocol, in accordance with some embodiments.

FIG. 12 illustrates one exemplary implementation of a computing device, in accordance with some embodiments.

### DETAILED DESCRIPTION

I. Introduction

The present application provides techniques for improving the timing and performance of wireless networks, including to provide Time Sensitive Networking (TSN). Some embodiments described herein provide TSN over a wireless network to synchronize a mobile user equipment (UE) with a virtual clock domain. In some applications, providing TSN over a wireless network can provide support for dynamic and flexible UE configurations. Additionally, or alternatively, providing a TSN to the UE can enable scheduling of signal transmission/delivery and/or the enforcement of instruction execution according to timestamps in the virtual clock domain. Such precise time alignment between the UE and the other equipment in the virtual clock domain can enable implementation of facilities that depend on TSN, such as an Industrial Internet of Things (IIOT). In some embodiments, the time alignment between the UE and the virtual clock domain uses a physical layer signal of a radio frame and a time stamp encoded in the radio frame to provide high precision synchronization. In some embodiments, the UE and the virtual clock domain may be synchronized within very small time windows, such as within 1.5 μs or faster.

Advances in robotics and automation have provided highly configurable equipment with advanced features, such as equipment capable of performing dexterous functions (e.g., robotic picking applications, robotic implementation of steps of a manufacturing process, etc.) and self-navigation (e.g., for mobile robotic applications). For example, such robotics can provide for the possibly of automated manufacturing, where multiple mobile robotic components work in concert to execute industrial processes. In some applications, coordination between highly configurable robotics may require large volumes of data to be exchanged with low latency within set timing constraints. Given such low latency requirements, wired connections have been used to provide high-precision synchronization between devices, such as between the local clocks of different network components. When the local clocks of different network components are synchronized, those components may implement a virtual clock domain. The virtual clock domain represents the common reference time that each local clock in synchronized to. The precision of the virtual clock domain is directly related to the uncertainty between the time measured on a local clock of a network component and the reference time of the virtual clock domain.

The inventors have recognized that in various applications, such as those that include dynamic and/or reconfigurable equipment that is mobile, wired communication may not be possible and/or it may limit the mobility and/or degree of flexibility for configuring the equipment (e.g., which can impact the use case scenarios). The inventors have appreciated that advancements in wireless technologies, such as 5G networks and beyond, may provide high bandwidths to handle high-volume data transfer that may be used to synchronize instructions between different robotic network components within a pre-defined time error constraint. However, wireless communication between network components often includes additional associated delays, relative to wired communication protocols, that may further complicate and prevent precise synchronization between different robotic network components. For example, wireless communications may be susceptible to delays in wireless transmission/delivery and delays in processing received data. The inventors have appreciated that such additional delays may compound synchronization deviations. For example, such delays may cause deviations between the local clock of the network component and the reference time of a virtual clock domain, thus decreasing the precision of the synchronization. For example, two components operating in concert to perform an industrial process may produce costly, damaging, and/or dangers errors when the two components operate too far out of synchronization. For example, in some applications, delays larger than 1.5 μs may result in errors during manufacturing or damage to the components themselves. Thus, the speed and complexity of components in an IIOT facility may be limited based on the precision of synchronization between the clocks of each component in the virtual clock domain. While wireless operation may be desirable, additional delays added through the use of wireless communications can render conventional techniques inadequate to provide sufficient synchronization among devices using wireless communications.

The inventors have further recognized that it can be desirable or necessary to use critical process data in synchronized networks, such as to coordinate scheduled events between different instances of robotic equipment and/or to monitor the status of ongoing process. In some applications, critical process data may rely on signals from various applications and/or devices, such as signals from sensors and actuators in an IIOT facility. However, the inventors have appreciated that as process complexity increases, so too does the complexity of real time data that may be relied on to monitor critical process data for industrial processes. For example, in addition to real-time data, other types of data such as energy data metrics and maintenance reports may also be used in process monitoring.

The inventors have therefore recognized and appreciated that providing wireless TSN and real-time enforceable communication for transmitting critical process data, is a challenge to enabling dynamic industrial automation. Examples of industrial automation processes include collaborative robotics applications, high-precision manufacturing automation, closed-loop control applications, robot manufacturing, product packaging, federated multi-agent systems deployed in physical systems, automated production processes, large-scale machine-to-machine communications that are integrated for automation, smart monitoring, improved communications (i.e., Industry 4.0), and other applications. It can be desirable to implement such industrial automation processes using wireless communications via an IIOT facility that leverages critical process data in real-time. For example, it can be desirable to use TSN enforceable communications to provide data in real-time that is used for event scheduling. Enforceable communications provide signals and/or process instructions on a reliable schedule, such that other signal transmissions and/or processes may rely upon timely receipt the communications. For example, Isochronous task execution may rely on enforceable communications implemented through a TSN to synchronize multiple IIOT applications with a dedicated or decentralized system controller.

Recognizing the above challenges, the inventors have developed techniques to provide a synchronization protocol that uses, in part, a wireless channel of a network (e.g., a cellular network). In some embodiments, the synchronization techniques can provide sufficient synchronization to support Time-Sensitive Networking according to the standard IEEE 802.1AS. In some embodiments, the techniques can leverage a first synchronization protocol for one or more wired portions of the network, and a second synchronization protocol between the wired network and the wireless devices (e.g., between small cells and UEs and/or other mobile devices). In some embodiments, for example, radio frames of the wireless network can be used to provide wireless synchronization. Such approaches can allow for implementing TSN over cellular networks, such as over 5G networks. As a result, highly sophisticated and closely coordinated architectures can be provided using the techniques described herein that are not otherwise available using conventional approaches. Accordingly, the TSN techniques described herein provide improvements over conventional synchronization technology by allowing for wireless TSN implementations. As described herein, such wireless implementations can address the problems that the inventors have appreciated with wired TSN approaches, including providing for TSN implementations with wireless components, as well as wireless TSN implementations that can leverage critical process data.

For example, a cellular network device may implement a computerized method including, receiving, by the cellular network device, timing information from a cellular network node. The cellular network node may be in wired communication with a network clock reference and the cellular network node may be in communication with the network device. The timing information associated with the network clock reference and the timing of the network device is in accordance with the synchronization protocol. The computerized method my further include, determining, by the network device, a timing adjustment based on the timing information, and adjusting, based on the timing adjustment, a timing signal that is transmitted by the network device to a user device in cellular communication with the cellular network node through the network device, where the timing signal is used to adjust a timing of the user device in accordance with the synchronization protocol.

II. Exemplary Network Configurations

Techniques described herein, such as techniques including a wireless TSN synchronization protocol, to synchronize user equipment with a reference clock over a wireless channel of a cellular network can be employed in various network configurations and utilizing various network protocols. A set of TSN standards devoted to the time-sensitive transmission over Ethernet networks provide for interoperability among different applications. Aspects of the technology described herein relate to improving TSN functionality on a wireless network to provide a wireless TSN.

The inventors have appreciated that, to provide a TSN using a wireless network, delays introduced in wireless transmission protocols may decrease the precision of synchronization. To improve the precision of synchronization, in some conventional approaches a UE may include separate, dedicated precision timing equipment, such as GPS equipment, to receive precise timing signals from the dedicated TSN network. A TSN translator may use mobile signals, received through a primary wireless network, and the precise timing signals from the dedicated TSN network to calculate the scheduled timings associated with critical process data.

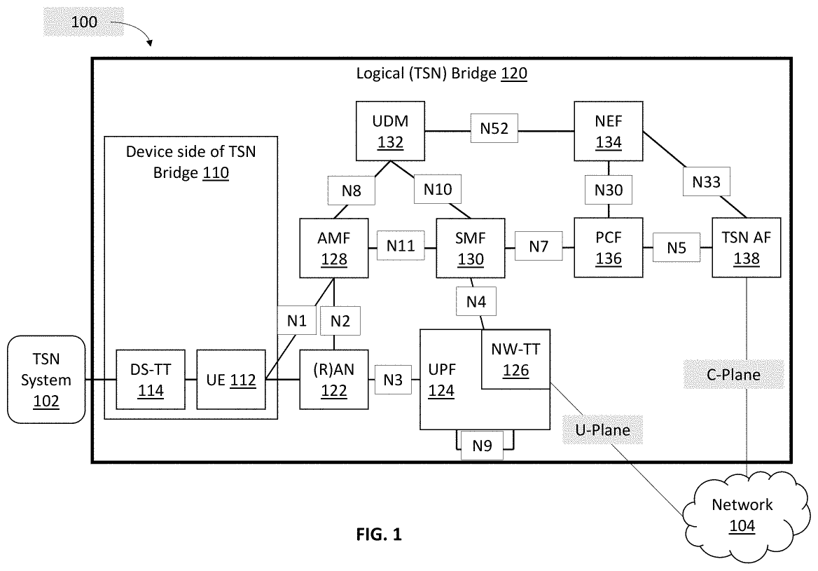

FIG. 1 illustrates an exemplary TSN architecture 100 configured with a 5G network and a dedicated TSN network. TSN architecture 100 includes TSN system 102 communicatively coupled to UE 112 through the Device side of the TSN bridge 110. UE 112 is further communicatively coupled to network 104 through a logical TSN bridge 120. Logical TSN bridge 120 provides TSN compatible communications with network 104. Logical TSN bridge 120 includes device side TSN bridge 110, (Radio) Access Network (RAN) 122, User Plane Function (UPF) 124, network side TSN translator (NW-TT) 126, Access & Mobility Management Function (AMF) 128, Session Management Function (SMF) 130, Unified Data Management (UDM) 132, Network Exposure Function (NEF) 134, Policy Control Function (PCF) 136, and TSN Application Function (TSN AF) 138. Device side TSN bridge 110 includes user equipment 112 and device side TSN translator 114.

As shown in FIG. 1, network components are communicatively coupled by multiple network interfaces, including network interfaces N1, N2, N3, N4, N5, N7, N8, N9, N10, N11, N30, N33, and N52. In the exemplary network configuration shown in FIG. 1, UE 112 communicates with (R)AN 122 by exchanging radio frames. Network interface N1 provides connectivity between UE 112 and AMF 128. Network interface N2 provides connectivity between (R)AN 122 and AMF 128. Network interface N3 provides connectivity between (R)AN 122 and UPF 124. Network interface N4 provides connectivity between UPF 124 and SMF 130. Network interface N8 provides connectivity between AMF 128 and UDM 132. Network interface N9 provides connectivity between two UPFs. Network interface N10 provides connectivity between SMF 130 and UDM 132. Network interface N11 provides connectivity between AMF 128 and SMF 130. Network interface N7 provides connectivity between SMF 130 and PCF 136. Network interface N52 provides connectivity between UDM 132 and NEF 134. Network interface N30 provides connectivity between PCF 136 and NEF 134. Network interface N5 provides connectivity between PCF 136 and TSN AF 138. Network interface N33 provides connectivity between TSN AF 138 and NEF 134. The network interfaces are numbered in accordance with 3GPP standards for 5G networks. Although illustrated with reference to 5G network systems, other network configurations are also possible. For example, the techniques described herein could also be applied to other network systems such as 6G network systems or other network systems that could implement TSN, as the techniques described herein are not limited in this respect.

The UE 112 and DS-TT 114 are configured as the device side of the TSN bridge 110 to interface TSN system 102 with UE 112 to receive precise timing signals. UE 112 is also coupled to the primary 5G network components that provide C-plane and U-plane functionality. The 5G network components may transmit signals and/or instructions associated with a TSN process to UE 112. For example, the TSN AF 138 translates control and management plane functions to interact with 5G network resources. The NW-TT (126) is integrated with the UPF and provides an interface between the 5G system and the internet that translates data plane functions to interact with 5G network resources. The DS-TT provides and interface between the TSN system 102 and UE 112 and is configured to use precise timing signals received from TSN system 102 to translate 5G messages received from the 5G network to UE 112 to implement TSN functionality. TSN translators NW-TT 126, DS-TT 114, and TSN AF 138 form a virtual clock domain such that TSN timestamps may be generated/interpreted with reference to a shared reference clock of the virtual clock domain.

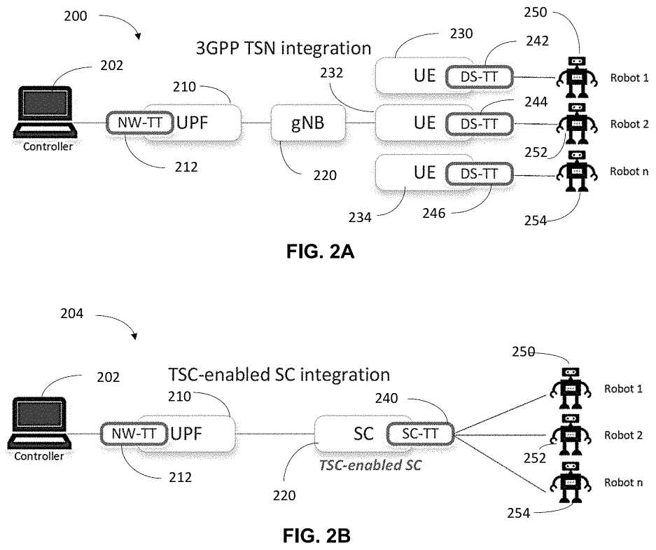

The inventors have recognized and appreciated that including a TSN translator with the UE typically increases equipment cost and may utilize computationally expensive process to accurately synchronize TSN signals with the primary wireless network. To address these challenges, the inventors have developed techniques for separating the UE TSN facility from the UE by implementing a TSN translator at the wireless cell providing network connectivity to the UE. By implementing the TSN translator at the wireless cell, a high precision synchronization between the UE and the virtual clock domain may be maintained through the wireless network. Implementing the TSN translator at the wireless cell may provide TSN functionality to multiple instances of UE from a single TSN translator which reduces the number of TSN translators used, decreasing the cost and complexity of the UE. The wireless cell translator may use physical layer signals transmitted with the radio frame for synchronization which may increase the synchronization accuracy by reducing the number of signals/networks involved in providing TSN. For example, physical layer signals transmitted with the radio frame including the primary synchronization signal, secondary synchronization signal and extended synchronization signal may be utilized by the network cell to synchronize the UE clock with the virtual clock domain. Physical layer signals may provide for more accurate synchronization than application or transport layer signals/messages. FIG. 2A and FIG. 2B illustrate some of the differences between a network with device side TSN translators and a network with a wireless cell TSN translator.

FIG. 2A illustrates an exemplary network 200 including a TSN system integrated into a 3GPP network architecture. Network 200 includes controller 202; UPF 210; NW-TT 212; gNodeB (gNB) 220; UE 230, 232, and 234; DS-TT 242, 244, and 246; and equipment instances 250, 252, and 254. As illustrated in FIG. 2A, controller 202 may transmit, using the network provided through UPF 210 and gNB 220, scheduled signals and/or instructions to UE 230-234. Controller 202 may be implemented as an industrial controller configured to generate time sensitive instructions for UE 230, 232, and 234 to execute automated industrial processes. Controller 202 is communicatively coupled to UPF 210. UPF 210 includes NW-TT 212 to interface network 200 with the internet. NW-TT 212 is communicatively coupled to the internet and to a grandmaster clock. The NW-TT provides an entry gateway into the 5G network from other network protocols. For example, NW-TT 212 may send/receive packets from the internet through an Ethernet protocol and may transmit/receive packets, through the UPF, in accordance with a 5G packet protocol. To integrate a TSN system into the 3GPP network architecture, independent equipment instances 250, 252, and 254 each have a dedicated UE and DS-TT to translate 5G messages for operating with TSN functionality. The 5G messages may be transmitted using a gPTP protocol. As shown in FIG. 2A, each UE 230, 232, and 234 includes a DS-TT 242, 244, 246, respectively. DS-TT 242, 242, and 246 each decode 5G packets, transmitted from gNB 220, and provide the corresponding messages to a listener of for their respective UEs 250, 252, and 254.

As described above, the inventors have appreciated that developing the support of a TSN client for UEs uses dedicated processing resources which may increase the overall complexity of the TSN system, or the costs associated with each instance of equipment. Referring again to the example in FIG. 2A, as the number of instances of equipment increases (e.g., adding additional robotic components) the number of mobile UE and DS-TT increases proportionally. Thus, controller 202 may provide instructions to multiple equipment instances to coordinate the execution of processes on different instances of equipment with a common understanding of time established by the virtual clock domain. The TSN system illustrated in FIG. 2A includes n equipment instances of robotic assemblers. To coordinate the n instances of equipment each instance has a corresponding DS-TT, resulting in n DS-TTs. Thus, the cost of scaling additional equipment instances includes proportionally increasing the number of DS-TTs. The inventors have further appreciated that since each DS-TT determines its own local clock time, the jitter between different DS-TTs may compound uncertainties between the local clocks of each equipment instance. Thus, including more equipment instances into a coordinated process results in an increased uncertainty in the synchronization between the included equipment instances.

As discussed above, the inventors, having recognized this challenge, have developed techniques that implement the role of the TSN translation using a network cell. In some embodiments, the TSN translator is implemented using a small cell base station (SC) providing gNB functionality to UEs. By implanting the TSN translator using a small cell, the number of TSN translators used to synchronize the UEs may be reduced. Although embodiments described herein reference implementations using a SC, the technology described herein is not limited in this respect. In some embodiments, other network cells may also be used. For some applications small cells may provide increased synchronization precision relative to other network cells.

FIG. 2B illustrates an exemplary network 204 configured for time sensitive communication (TSC) using a small cell with a small cell integrated TSN Translator (SC-TT), in accordance with some embodiments. Network 204 includes controller 202, UPF 210, NW-TT 212, small cell (SC) 220, small cell TSN Translator (SC-TT) 240, and robotic components 250, 252, & 254. Controller 202. Controller 202, UPF 210, and NW-TT 212 may be configured in accordance with the configuration in FIG. 2A. However, in contrast to network 200 in FIG. 2A, network 204 reduces the number of TSN translators used to synchronize the robotic components. A single SC configured with SC-TT 240 determines the local times for each equipment instance and transmits signals indicative of the local times for each equipment instance to the respective instance.

In some embodiments, controller 202 is configured to coordinate timestamps associated with the TSN facility. In some embodiments, controller 202 is configured to transmit a downlink timestamp to the TSN facility. The downlink timestamp may be associated with a process to be executed by the TSN facility. For example, the downlink timestamps may specify a portion of a process to be executed by one of robotic components 250-254 and a time for execution.

In some embodiments, controller 202 is configured to receive an uplink timestamp from the TSN facility. The uplink timestamp may be associated with data from sensors and/or manufacturing equipment associated with the TSN facility. For example, time stamped confirmation of process execution or scheduling of execution may be transmitted to controller 202 so that controller 202 may update or schedule subsequent instructions. As another example, sensors or smart monitors may transmit uplink data to controller 202. Data from the sensors or smart monitors may be used to determine when portions of the process should be executed.

As described above, in connection with FIG. 2A, NW-TT 212 interfaces network 204 with the internet. For example, in a 5G TSC-enabled network architecture, NW-TT 212 is the interface between the 5G system and the internet. In other embodiments, the network may be a 6G TSC-enabled network architecture. In such embodiments, the NW-TT is the interface between the 6G system and the internet.

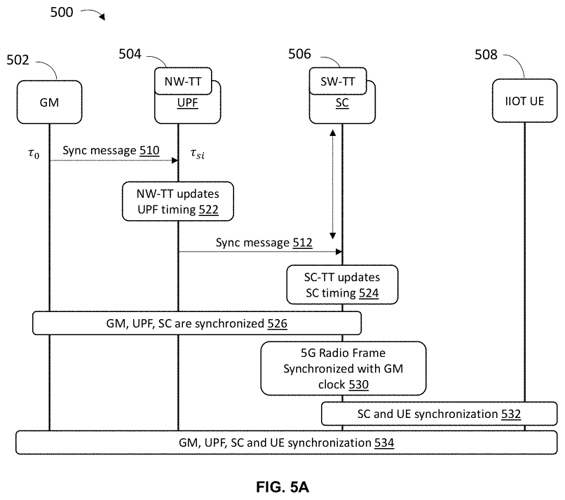

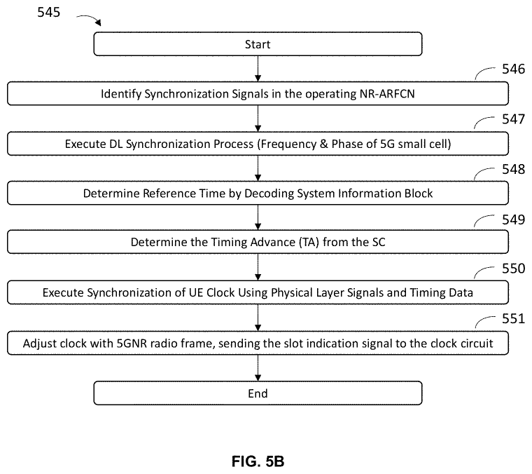

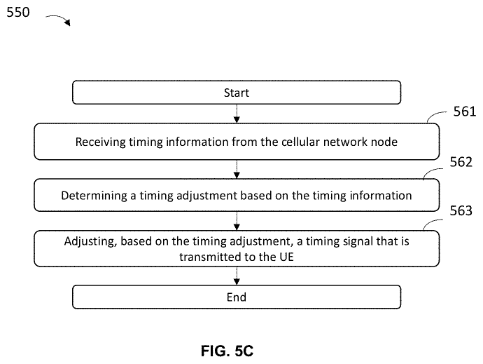

In FIG. 2B, incorporation of TSN synchronization into the SC provides synchronization of the UE with the virtual clock domain using physical layer signals of the wireless network transmitted between the SC and the UE. The SC also provides timestamps and related process information through data encoded within the data frame. Thus, the integration of the TSN functionality with the radio frame enables the UE to receive one signal that includes both the synchronization and reference times used in implementing TSN. In this sense, implementing the UE instance to have high accuracy time synchronization (1.5 μs or faster) may be accomplished by utilize existing low-cost local oscillators that may already be integrated within the electronic systems of the UE and the SC. In this sense, synchronization processes are handled by the small cell and the equipment instances extract the time and synchronization from the 5G radio frame as described in further detail below with reference to FIGS. 5-8.

Referring to FIGS. 2A and 2B, the SC-TT, of FIG. 2B, may improve the synchronization precision, relative to the gPTP integration with a dedicated TSN network of FIG. 2A, both by providing precise synchronization signals and by reducing the impact of translation errors. As an example, in the 3GPP configuration of FIG. 2A, the gPTP protocol ends at each UE and transmits separate signals for each UE. From the perspective of the dedicated TSN network, each UE is an end station where the translation of the gPTP protocol to the TSN protocol is performed. By contrast, in FIG. 2B, the gPTP protocol terminates at the small cell. Thus, from the perspective of the TSN GM, the small cell is the end point of the gPTP protocol and a single TSN translator converts the gPTP protocols into TSN protocols for multiple UEs. This approach reduces the compounding of errors that may be present when translating between protocols. If there are any errors in translating between protocols, then each UE receiving signals from the same SC will be subject to the same error. Thus, the local clocks between each UE will still be synchronized together with a precision unaffected by the translation error.

In some embodiments, the modem in the SC includes dynamic resource schedulers that take into account the link delay between the SC and each equipment instance. The dynamic resource schedulers may also account for the residence time between the NW-TT and the SC-TT. In this configuration, the time differences between equipment instances are monitored at the edge of the network, independent of residence time delays, providing more precise timing keeping.

In some embodiments, the individual signals for different UEs are broadcast together in a multiplexed configuration such that the signals configured for different UEs in the TSN do not interfere with each another. For example, a small cell may operate in Time-Domain Division (TDD) mode, such that the signals configured for different UEs do not interfere. In network configurations with multiple small cells operating in concert to provide a multi-SC TSN, the SCs may additionally configure signals such that the signals from different small cells do not interfere using techniques such as TDD, beam forming, beam steering, and/or beam switching. For example, the transmissions of the different cells in a TDD network may be synchronized to avoid intercell and inter-subframe interference. In some embodiments, a local and/or private industrial network may include multiple SCs to provide TSN of UEs across a large industrial network. For example, multi-SC networks may transmit signals according to 3GPP standards such as TS 38.104.

III. Synchronization Technique

As described above, the inventors have recognized and appreciated that providing a wireless TSN network provides challenges. Implementations that use a dedicated TSN system, separate from the primary wireless network, may increase complexity and cost of the UEs. To address the above-described challenges, the inventors have developed a physical-layer procedure which disciplines the device clock, using a timing signal extracted from the 5GNR radio frame slot or OFDM symbol to achieve the desired synchronization accuracy. In some embodiments, the SC-TT embedded in the small cell is a gPTP instance that guarantees the synchronization and the accuracy of the 5G NR radio frame to enforce the synchronization and the accuracy of the 5G NR radio frame to maintain enforcement of the synchronization across the 5G industrial network.

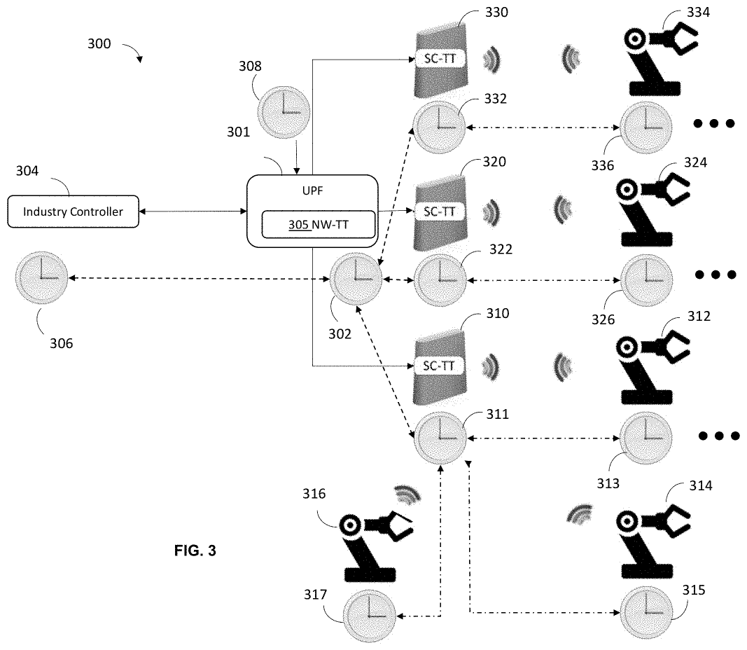

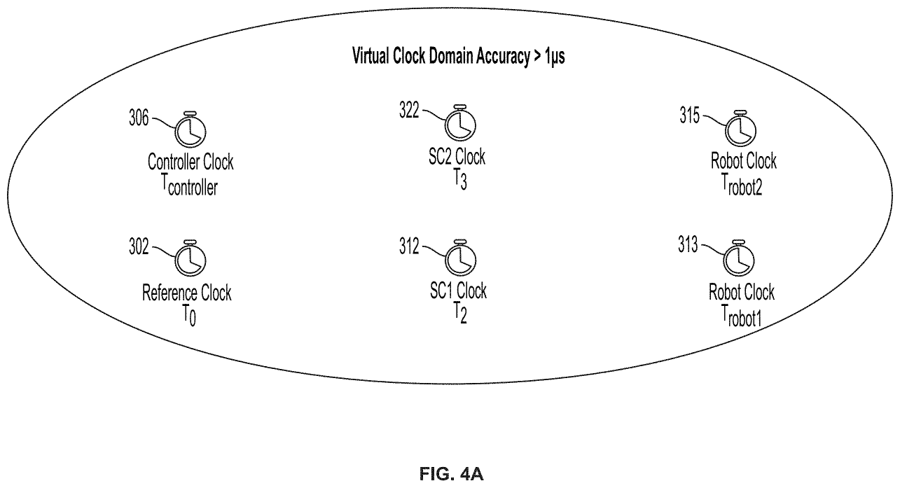

FIG. 3 illustrates a private industrial network 300 with a small cell that includes a TSN translator, in accordance with some embodiments. Private industrial network 300 includes multiple small TSC enabled small cells (TSC-SC), the first small cell 310, second small cell 320, and third small cell 330 each communicate with UPF 301 for access to the internet and industry controller 304. Each TSC-SC may provide wireless connectivity to multiple equipment instances. NW-TT 305 provides an interface between the 5G system and the internet. Equipment instances 312, 314, 316, 324, and 334 with UE clocks 313, 315, 317, 326, and 336 wirelessly communicate with small cells 310, 320, and 330.

Network components have a local clock for local time keeping. The local clocks may all be synchronized to a reference clock to provide a common understanding of time across the different network components, forming a virtual clock domain. For example, a grand master clock 308 may provide a time from an atomic clock, such as atomic clock affiliated with the GPS system or with a national time keeping standards system. Controller clock 306 is synchronized with reference clock 302 and provides a controller with a local time which may be used in scheduling events or interpreting incoming signals.

As shown in FIG. 3, SC1 clock 312 and SC2 clock 322 are synchronized with reference clock 302, and UE clocks 313 and 315 are synchronized with SC1 clock 311. The synchronization of the UE clocks with a SC clock and synchronization between the SC clock and the reference clock provide synchronization between the UE clocks and the reference clock. In this way, each clock in the virtual clock domain has a common reference time. Thus, when the controller schedules instructions for Robot 1 and Robot 2 to coordinate an assembly process, both Robot 1 and Robot 2 will be able to execute their respective portions of the assembly process at the prescribed time without interfering with each another. In some embodiments, the virtual clock domain accuracy is better than 1 μs. In some embodiments, the virtual clock domain accuracy is better than 0.5 μs. In some embodiments, the virtual clock domain accuracy is better than 250 ns.

The SC that provides access for UEs to the core network may communicate with other network components through wired connections, and communicate with the UEs through wireless connections, in accordance with some embodiments. For example, the small cells 310, 320, and 330 and industry controller 304 are each in wired connection to UPF 301, as indicated with solid lines. Small cells 310, 320, and 330 wireless communicate with equipment instances 312, 314, 316, 324, 334 as indicated by the three-arc wireless symbol. In some embodiments, the wired connection may communicate using an Ethernet protocol.

In some embodiments, the wireless connections may communicate through a 5G 3GPP protocol. In other embodiments, the wireless connections may communicate through a 6G 3GPP protocol. In yet other embodiments, the wireless connections may be compatible across generations of 3GPP protocols. For example, the wireless connections may communicate with some UEs using a 5G protocol and with other UEs using a 6G protocol. In some embodiments, the wireless connection used to communicate with UEs may depend on available resources, quality of service, and/or anticipated bandwidth requirements. In other embodiments, other wireless communication protocols capable of being integrated with a TSN system may be used, as aspects of the technology described herein are not limited in this respect.

Network components that communicate through wired connections may be synchronized through a first timing protocol, and network components that communicate through wireless connections may be synchronized through a second timing protocol. In some embodiments, the first timing protocol may be a gPTP protocol. In FIG. 3, Network components that communicate though the gPTP protocol are connected with dashed lines while clocks that are synchronized using a wireless TSN protocol are connected with dash-dot lines.

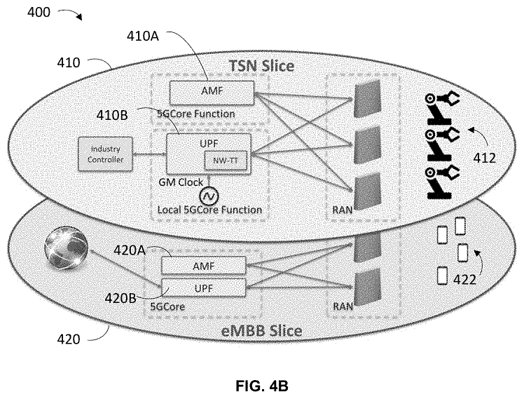

As a result of the synchronization techniques described in connection with FIG. 3, network components that communicate through wired connections and network components that communicate through wireless connections form a virtual clock domain. FIG. 4A illustrates a virtual clock domain including network components illustrated in FIG. 3, in accordance with some embodiments. A virtual clock domain enables coordination of otherwise independent clocks across the nodes of the network to provide a distributed common timescale with a defined accuracy. The accuracy of a virtual clock domain is based on the uncertainty of each clock relative to the reference time. As shown in FIG. 3, grand master clock 308 provides a reference time to the UPF to maintain synchronization of reference clock 302. Controller clock 306 is synchronized with reference clock 302 and provides a controller with a local time which may be used in scheduling events or interpreting incoming signals. SC1 clock 312 and SC2 clock 322 are synchronized with reference clock 302. UE clocks 313 and 315 are synchronized with SC1 clock 312 and, by extension, reference clock 302. In this way, each clock in the virtual clock domain has a common reference time. Thus, when the controller schedules instructions for Robot 1 and Robot 2 to coordinate an assembly process, both Robot 1 and Robot 2 will be able to execute their respective portions of the assembly process at the prescribed time without interfering with each another. In some embodiments, the virtual clock domain accuracy is better than 1.5 μs. In some embodiments, the virtual clock domain may have other accuracies, as described herein.

In some embodiments, the synchronization may have an accuracy of 1.5 μs. A synchronization accuracy of 1.5 μs may provide the timing between small cells in the network to be within 1.5 μs of the reference clock. In FIG. 4A, the time kept by reference clock 302 and the time kept by the first SC1 clock 311 may be within 1.5 μs of each other. Additionally, the time kept by SC1 clock 311 and the time kept by SC2 clock 322 may be within 1.5 μs of each other. The timing between UEs communicatively coupled to the same small cell may each be synchronized to within 1.5 μs. For example, the time kept by UEs clocks 313, 315, 317 communicatively coupled to SC 310 may be within 1.5 μs of SC1 clock 311. Additionally, the timing between UEs that are communicatively coupled through different small cells may be synchronized to within 1.5 μs. For example, time kept by UE clock 326 may be within 1.5 μs of the time kept by UE clock 313.

In connection with providing TSN functionality, the network should provide message delivery with guaranteed delivery of the time-constrained messages and/or signals. To provide the guarantee of message delivery, Quality of Service (QoS) policies may be implemented to prioritize the performance of different types of traffic and/or traffic coming from different UEs. In some embodiments, the QoS may be implemented through the deployment of a dedicated Network Slice. Network Slices are isolated, virtual end-to-end networks configured to fulfil specific parameters and/or requirements. For example, a network slice may be configured to provide specific QoS requirements in terms of latency and reliability of the TSN application.

FIG. 4B illustrates network 400 including a dedicated virtual TSN slice, in accordance with some embodiments. As shown in FIG. 4B, resources from the AMF and UPF may be dedicated to the virtual TSN slice. In some embodiments, network resources that provide access to the AMF and UPF may allocate dedicated resources to the separate network slices providing different services. Virtual network slices may be implemented by dedicating a portion of computing capacity to provide a dedicated function or service to devices communicating with the network slice. In some embodiments, the TSN slice 410 may be deployed together with a standard network slice 420 to support the standard 5G smartphones 422 and UEs 412 as shown in FIG. 4B. For example, the TSN slice 410 may include dedicated resources from the AMF 410A and UPF 410B to provide functionality to the UEs 412. Additional AMF 420A and UPF 420B resources may be allocated to a virtual eMBB slice 420. The eMBB slice 420 provides 5G network communication to smartphones 422. In some embodiments, network 400 may include additional slices to provide different functionalities and/or quality of service.

FIG. 5A illustrates end-to-end synchronization process 500, in accordance with some embodiments described herein. As shown in FIG. 5A, the end-to-end synchronization provides synchronization of an industrial internet of things (IIOT) UE 508 with a grand master (GM) clock 502. Synchronization between the GM 502 and the UE 508 may use a first timing protocol for receiving a reference time and a second timing protocol for enforcing synchronization of UE 508. For example, UPF 504 may include a NW-TT for encoding timing signals in accordance with a 5G network protocol. SC 506 may include SW-TT to decode timing signals from UPF 504 and to synchronize the first timing protocol with the second timing protocol. SC 506 may use the second timing protocol to synchronize UE 508 to the reference time of GM 502.

In some embodiments, UPF 504 receives sync message 510 from GM 502. Using sync message 510, UPF 504 may implement a first timing protocol to synchronize UPF 504 with SC 506, where NW-TT and SW-TT implement a synchronization protocol in accordance with a Precision Time Protocol. For example, NW-TT and SW-TT may implement synchronization using the IEEE 802.1AS standard. Implementation may be in accordance with the 3GPP TS 23.501 specification. The 5G network may be transparently integrated with the TSN network. In some embodiments, integration between the 5G network and the TSN network may be implemented as a bridge in accordance with IEEE 802.1 standards.

UPF 504 uses sync message 510 to update the local clock at the UPF. In some embodiments. NW-TT updates UPF timing 522 according to IEEE 802.1AS. In some embodiments, GM 502 may directly communicate with UPF 504. In some embodiments, UPF 504 may indirectly receive sync message 510 from GM 502. For example, network 500 may include multiple UPF facilities, and UPF 504 may receive sync message 510 from an intermediary UPF, where the intermediary UPF is in direct communication with GM 502. In some embodiments, network 500 may include multiple intermediary UPFs, and UPF 504 may receive multiple sync messages to determine which intermediary UPF can provide sync message 510 with the shortest latency.

As described above in connection with FIG. 2B, the first timing protocol, implemented using the NW-TT and SW-TT, may treat the SC as the endpoint of the TSN timing domain. For example, the synchronized time at the SC in the first timing protocol may be represented by the following equation:

τ_{sc}=τ₀+δ_{link delay}+T_{residence} Equation 1

In Equation 1, τ_{sc} is the synchronized time of the SC; τ₀ is the reference time, received from the grandmaster clock; δ_{link delay} is the propagation time of the packet, including the sync message, through the cable from the GM to NW-TT; and T_{residence} is the residence time between the UPF and the SC expressed in GM time base. The link delay may be calculated according to the IEEE 802.1AS standard. The residence time is measured using ingress timestamps (tₛᵢ) and egress timestamps (tₛₑ). For example, the tₛᵢ is recorded when sync message 510 is received at UPF 504, and tₛₑ, is recorded when sync message 512 is received at SC 506. The residence time may be represented by the following equation:

T_{residence}=tₛₑ−tₛᵢ×RateRatio Equation 2

In Equation 2, the rate ratio is the ratio between the frequency of the GM clock to the local clock of the SC. The RateRatio may be determined according to the IEEE 802.1AS standard.

Referring again to FIG. 5A, SC 506 uses sync message 512 to update the local clock at the SC. In some embodiments, SC-TT updates the SC timing according to IEEE 802.1AS. Following the update of the SC clock by the SC-TT, GM 502, UPF 504 and SC 506 are synchronized. In some embodiments, GM 502, UPF 504, and SC 506 are synchronized according to 3GPP 23.501 release 16 for downlink synchronization and 3GPP 23.501 release 17 for uplink synchronization.

The second timing protocol 532 synchronizes SC 506 and UE 508. The second timing protocol may be implemented using physical layer signals of the 5G NR radio frame to enforce relative synchronization between SC 506 and UE 508. Once synchronized, SC 506 may use time information encoded in the 5G NR radio frame to determine the actual synchronization time. In some embodiments, the time that the radio frame is received may be synchronized with the timing interval of the virtual clock domain such that the UE may use the arrival of the radio frame and the time information to determine a synchronization time. In some embodiments, the time information encoded in the 5G NR radio frame may include System information block 9 (SIB9) that includes Coordinated Universal Time (UTC) data. In some embodiments, the 5GNR radio frame is transmitted using the Radio Resource Control (RRC) protocol with the timing information encoded in SIB9.

In some embodiments, the UE may perform the Random-Access Procedure to register with the SC to initiate data transmission. The SC may use the Random-Access Procedure to determine the timing advance (i.e., the time it takes for signals to travel between the SC and the UE). The timing advance may be used in connection with determining the synchronization time, as described herein.

The internal clock cycle of UE 508 may be adjusted based on the arrival time of the radio frame and the decoded UTC data such that the UE 508 will be synchronized with the arrival time of the radio frame. Additionally, the arrival time may be used as a reference relative to the time encoded in the information block. For example, by synchronization of the discrete time periods of the UE, with timing intervals of the virtual clock domain, the UE may precisely determine when the reference time, encoded in the information block, was counted. In discrete time, the time incrementally jumps from one time period to the next. If the time period for a clock is 1 μs, then time would incrementally count in 1 μs increments. Clocks may use a periodic signal, such as a square wave, with a periodicity corresponding to the desired time period to count incrementally. At each falling edge of the square signal, the clock adds one increment to the current time of the clock. When the virtual clock domain and the UE 508 clock have unsynchronized time periods, the offset between the falling edge of the UE clock and the incrementing of time in the virtual clock domain introduces additional uncertainty into the synchronization. However, when the falling edge of the UE clock is synchronized with the incrementing of time in the virtual clock domain, UE 508 may precisely determine when a time occurs in the virtual clock domain. In some embodiments, the virtual clock domain and the UE may increment time on the same interval. In some embodiments, the virtual clock domain and the UE may increment time on different intervals and may synchronize on a common multiple of the two intervals.

Although the synchronization of the internal clock described herein uses the example of the falling edge for counting, other counting schemes may be used, as aspects of the technology described herein are not limited in this respect. For example, the rising edge of the periodic signal may be used. As another example, both the rising edge and the falling edge of the periodic signal may be used.

FIG. 5B illustrates process 545 of synchronizing the internal clock of the UE with the virtual clock domain, in accordance with some embodiments. Prior to the start of process 545, UE may be in a searching state. While searching, the UE may be on standby, the UE scans for synchronization signals transmitted from a wireless network. In some embodiments, the UE scans New Radio Absolute Radio-Frequency Channel Numbers (NR-ARFCNs) for synchronization signals.

Process 545 begins at block 546, where a UE identifies a synchronization signal associated with an NR-ARFCN for receiving downlink synchronization signals from a small cell, in accordance with some embodiments. The UE may include a 5GNR modem configured to communicate with a 5G network. In some embodiments the 5GNR modem may identify wireless synchronization signals associated with the 5G network. For example, the 5GNR modem may identify the Primary Synchronization Signals (PSS), the Secondary Synchronization Signal (SSS), and/or the Extended Synchronization Signals (ESS) in the Synchronization Signal Block (SSB) of the Radio Frame.

In other embodiments, the UE may include a modem configured to identify synchronization signals of other mobile networks, such as a 6G wireless network. In some embodiments, the modem may be configured to communicate with any wireless network that is compatible with implementing TSN, as aspects of technology described herein are not limited in this respect.

At block 547, once the 5GNR modem has identified the SSB, the modem executes a downlink synchronization process, in accordance with some embodiments. The downlink synchronization process synchronizes the frequency and the phase of the UE's radio transmitter and receiver with the SC. This procedure may use a Time Locked Loop (TLL) circuit to synchronize the UE's radio transmitter and receiver with the SC's radio transmitter and receiver. After the synchronization between the RF signal components of the UE and SC, the frequency and phase are synchronized.

At block 548, the UE determines the reference time, in accordance with some embodiments. To determine the reference time, the UE decodes System Information Block 9, which contains the information elements that may be used to determine the reference time at the SC clock. For example, the information elements decoded from System Information Block 9 may include the UTC reference time, leap seconds, and the UTC local time offset.

At block 549, the 5GNR modem determines the timing advance from the SC, in accordance with some embodiments. To determine the timing advance from the SC, the 5GNR modem initiates a connection process to the 5G network. For example, the 5GNR modem may initiate a connection through the Random-Access procedure on a random-access channel (RACH) of the network. Using the Random-Access procedure, the TSN-enabled SC determines the Timing Advance. The Timing Advance is the time that the radio signal takes to be transmitted from the UE to the TSN-enabled SC, as described herein. The TSN-enabled SC extracts the Timing Advance from the RACH response. The Timing Advance may be updated by the SC as the UE moves, transmission path changes, and/or the connection is interrupted. The UE may transmit a MAC Control Element, to indicate that the Timing Advance should be updated.

At block 550, the SC executes synchronization protocols of the UE clock using physical layer signals and subframe data, in accordance with some embodiments. The SC executes synchronization by transmitting physical layer signals of the radio frame, synchronized with the virtual clock domain, and transmitting timing data encoded in the radio frame. In some embodiments, physical layer signals associated with subframes of the radio frame may be used to synchronize the UE clock to the virtual clock domain of the TSN network by adjusting the transmission of the slot indication signal to correspond with the time of the virtual clock domain. For example, the first slot (Slot #0) of the first subframe (Subframe #0) of a radio frame will be coincident with a timing interval of the virtual time domain. The coincident arrival of the radio frame combined with the UTC time information decoded from the radio packet provides synchronization between the UE and SC that supports TSN. In some embodiments, a boundary signal associated with a symbol of the radio frame may be used to indicate the time of the virtual clock domain. The synchronization protocol is discussed in further detail below, with respect to FIG. 5C.

At block 551, following the synchronization of the UE clock to the virtual clock domain, the UE clock uses subsequent physical layer signals to keep the system synchronized in a loop operation, in accordance with some embodiments. The UE clock uses the physical layer signals to keep the frequency and phase synchronized during downlink and uplink transmissions. For example, when the UE receives subsequent slot indication signals, the UE may check and/or update the synchronization of the UE clock with the virtual clock domain. As another example, when the UE receives subsequent boundary signals associated with symbols of the radio frame, the UE may check and/or update the synchronization of the UE clock with the virtual clock domain.

As described above, enforcing scheduled events through a TSN is limited by the synchronization of the virtual clock domain that includes the UE performing the scheduled events. The internal clock signals used to transmit and receive wireless signals are very precise and may utilize picosecond, or even sub-picosecond precision for sampling frequencies to receive and transmit signals of a 5G network. The timing of these internal clocks, used for frequency sampling, may be adjusted frequently to account for changes in pathlength between the signal transmitter and receiver, multi-path transmission, and the time-variant conditions of the propagating radio frames. Thus, the timing of internal clocks may change relative to the time of a virtual clock domain. The inventors have recognized and appreciated the precise internal clocks, used to maintain the frequency and phase of the wireless signals, may be used to provide precise time keeping when provided with a reference time for translating the clock signals into a local time.

The inventors, having recognized that physical layer signals are faster than application or transport layer signals, have developed synchronization protocols that use physical layer signals as reference times, that reference the encoded times transmitted in the radio frame, to synchronize the local clock on a UE with the virtual clock domain. In some embodiments, the synchronization of the local clock on the UE with the virtual clock domain supports TSN functionality.

FIG. 5C illustrates a computerized TSN synchronization protocol, in accordance with some embodiments. Prior to the start of process 550, a UE may synchronize with a SC, as described above in connection with blocks 546-549 of process 545 above. In some embodiments, process 550 may be configured to support TSN according to the IEEE 802.1AS standard. Other standards that support TSN with sub-millisecond synchronization of components in the virtual clock domain may also be used, as aspects of the technology described herein are not limited in this respect.

Process 550 begins at block 561 where a SC receives timing information from a cellular network node, in accordance with some embodiments. The cellular network node may be in wired communication with the network reference clock. Through the wired connection between the cellular network node and the network reference clock, the cellular network node receives timing signals indicative of a reference time of the reference clock. The cellular network node is also in wired communication with the SC. The SC receives timing signals, through the wired communication with the cellular network node, indicative of the reference time from the network reference clock.

In some embodiments, the timing information, received by the SC, is associated with the network clock reference and the timing of the SC in accordance with the synchronization protocol. For example, the timing information may be a gPTP message that includes the residence time and transmission delays of the signal as it is transmitted to the SC.

In some embodiments, the SC may be a TSN-enabled SC. The TSN-enabled SC may be configured to provide wireless network access to UEs through wireless protocols. The wireless protocols may include any wireless protocol capable of providing TSN. For example, the wireless protocols may include a 5G wireless protocol. As another example, the wireless protocol may include a 6G wireless protocol.

In some embodiments, the cellular network node may be a UPF network component. The UPF network component may use Ethernet protocols to communicate through the wired connections to the reference clock and the UE. In some embodiments, the UPF network component may include multiple UPF network components as part of a network topology.

Next at block 562, the SC determines a timing adjustment based on the timing information, in accordance with some embodiments. The timing information includes the reference time and residence time of the packets as they are transmitted from a grandmaster clock to the SC. The residence time is further described above in connection with FIG. 5A. In some embodiments, the timing information also includes a timing advance (i.e., the time for the RF signal to travel from the SC to the UE's receiver). From the timing information, a virtual clock domain time is determined at which the UE will receive the radio frame transmitted from the SC. The synchronization time represents the time, in the virtual clock domain when the radio frame will arrive at the UE. The synchronization time is further described below, in connection with FIG. 7.

In some embodiments, the timing advance may be determined prior to the start of process 550. For example, the timing advance may be determined in connection with the initial synchronization between the 5GNR modem and the network, where the frequency and phase of the UE modem are synchronized with the frequency and phase of the transmit/receive components of the SC. The timing advance may be determined using the random-access process described above, in connection with FIG. 5B.

In some embodiments, the timing advance may be determined during the synchronization protocol to account for any changes in beam path, beam propagation, and/or movement of the UE relative to the SC. In some embodiments, the timing advance may be recalculated whenever the UE moves or there is a disruption in communication between the SC and the UE.

Next at block 563, the SC adjusts the timing signal that is transmitted to the UE, in accordance with some embodiments. The SC adjusts a timing signal of the radio frame to adjust the timing of the UE clock. In some embodiments, the timing signal of the radio frame may be a physical layer signal. For example, the timing signal may be a slot indication signal, as described herein. As another example, the timing signal may be a symbol boundary signal, as described herein.

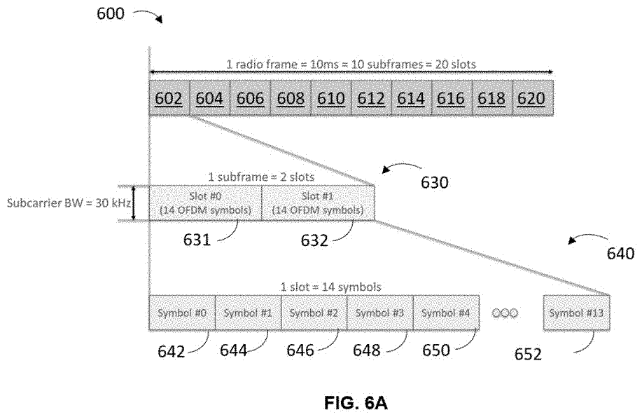

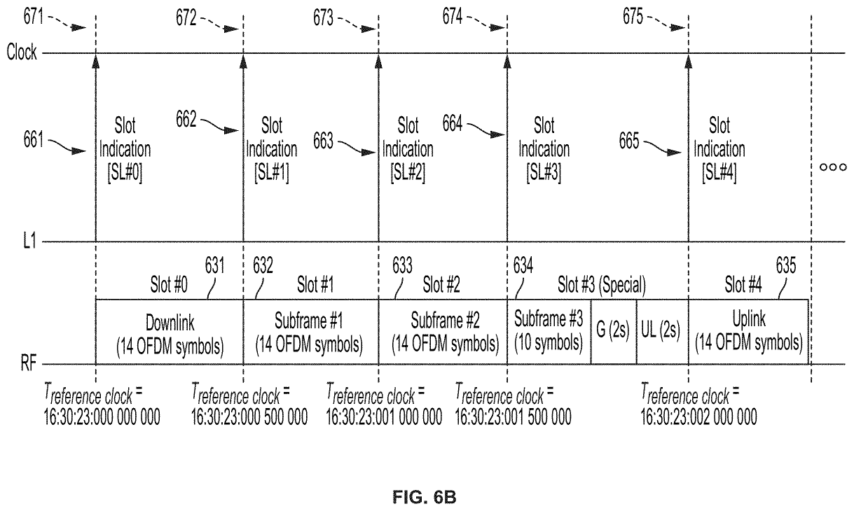

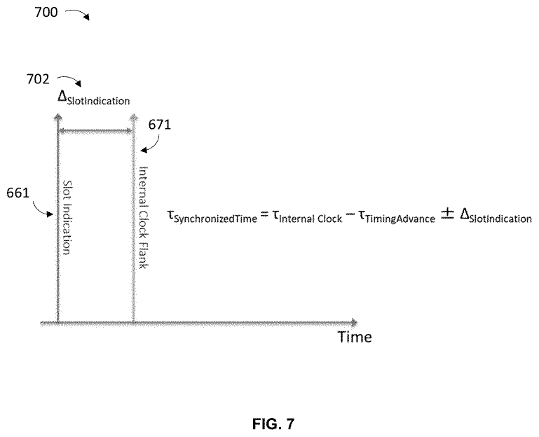

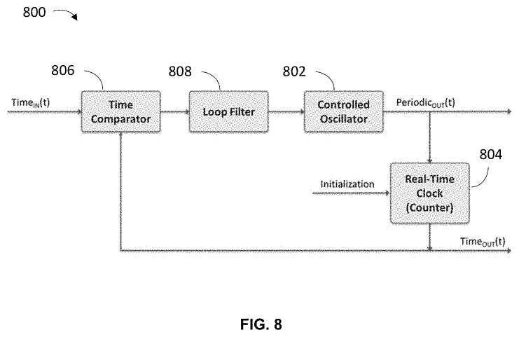

In some embodiments, the timing signal received by the UE is used in combination with a timing feedback circuit to adjust the internal clock flank of the UE. The feedback circuit is configured to adjust the timing of the internal clock flank such that the flank is coincident with subsequent timing signals. The synchronization of the UE clock to the virtual clock domain using a physical layer signal of the wireless network is discussed in further detail below in reference to FIG. 6A—FIG. 8.

FIG. 6A is a schematic of a radio frame 600 that may be used in accordance with the embodiments described herein. FIG. 6A illustrates a radio frame that is subdivided into 10 subframes 602, 604, 606, 608, 610, 612, 614, 616, 618, and 620. Each of the subframes includes one or more slots. In radio frame 600, each subframe 602-620 includes two slots. The two illustrated slots 631 and 632 correspond to subframe 602. Each slot includes 14 symbols, as indicated by symbols 642, 644, 646, 648, 650, and 652 that each correspond to slot 631 in FIG. 6A.

The number of slots in a subframe is determined by the subcarrier spacing (i.e., subcarrier bandwidth). In the illustrated exemplary radio frame 600, the subcarrier spacing is 30 kHz. However, other common subcarrier spacings that would be supported by a wireless network may be used. For example, subcarrier spacings of 15 kHz, 60 kHz, 120 kHz, and 240 kHz may be used. When a subcarrier spacing of 15 kHz is used, each subframe includes a single slot. When a 60 kHz, 120 kHz, or 240 kHz subcarrier spacing is used, the respective subframes will have 4, 8, or 16 slots.

The duration of radio frame 600 is 10 ms and includes 10 subframes. Each subframe includes a variable number of slots and each slot, regardless of the subcarrier spacing, includes 14 symbols. Therefore, as the number of slots per subframes increases, the symbol duration decreases, because the subframe duration is constant. The number of slots and the slot duration depends the on subcarrier spacing. For example, subcarrier spacings of 15 kHz, 30 kHz, 60 kHz, 120 kHz, and 240 kHz correspond to 1 slot per subframe, 2 slots per subframe, 4 slots per subframe, 8 slots per subframe, and 16 slots per subframe with slot durations of 1 ms, 0.5 ms, 0.25 ms, 0.125 ms, and 0.0625 ms respectively, that have symbol durations of 71.42 μs, 35.71 μs, 17.86 μs, 8.93 μs, and 4.46 μs respectively.

The configuration of symbols within a slot may be configured as downlink, uplink, or flexible (i.e., either uplink or downlink) symbols. A slot indicator signal may be transmitted to the UE to specify the symbol allocation within each slot. In some embodiments, the slot indicator may be transmitted using a DCI protocol. The slot indicator may include an indication of the periodicity of the symbols configured in a downlink-uplink pattern, a number of consecutive full downlink slots at the beginning of each downlink-uplink pattern, a number of consecutive downlink symbols in the beginning of a partially-filled slot, a number of consecutive full uplink slots at the end of each downlink-uplink pattern, and/or a number of consecutive uplink symbols at the end of a partially-filled slot. In some embodiments, the slot indicator may be configured in accordance with other formats which are configured to provide the UE with an indication of slot and/or symbol usage.

In some embodiments, a slot indication signal may be transmitted, by the SC, such that the arrival of the slot indication signal corresponds with a flank signal of the SC clock. FIG. 6B illustrates a schematic of the timing between the SC clock flank signal and subframes of the radio frame, in accordance with some embodiments. FIG. 6B illustrates slots 631, 632, 633, 634, and 635 that are the first five slots of radio frame 600. Prior to transmitting the payload of each slot, indication signals 661, 662, 663, 664, and 665 are each transmitted to the UE. The timing of the UE clock flank signals 671, 672, 673, 674, and 675 are illustrated by vertical dashed lines.

In FIG. 6B time progresses along the x-axis, increasing from left to right. The first five subframes of a radio frame are transmitted to a UE and the position of the slots indicate the arrival time of each respective slot at the UE. As indicated by the vertical alignment of the slots, slot indication signals, and the flank signal of the UE clock, each are synchronized in time. Thus, the slot indication signals may act as a reference time for translating the clock signals into a local time when the arrival of the slot indication signal corresponds to the time data encoded in the time information block of the radio frame. To provide synchronization with the reference time, the SC transmits the slot indication such that it arrives at an even timing interval of the reference time. In the illustrated embodiments of FIGS. 6A & 6B, the subcarrier spacing is 30 kHz. Thus, the slot duration is 500 μs, and a new slot indicator is transmitted every 500 μs. In the illustrated example of FIG. 6B, the time format is hours:minutes:seconds:milliseconds microseconds nanoseconds. The slot indicators are transmitted such that they arrive at the UE when the reference time is integer multiple of 500 μs. Slot indication signal 661 arrives at the UE when reference time is 16:30:23:000 000 000. Slot indication signal 662 arrives at the UE when the reference time is 16:30:23:000 500 000. Slot indication signal 663 arrives at the UE when the reference time is 16:30:23:001 000 000. Slot indication signal 664 arrives at the UE when the reference time is 16:30:23:001 500 000. Slot indication signal 665 arrives at the UE when the reference time is 16:30:23:002 000 000.

The enforcement of the arrival time of the indication signals enables the UE to maintain precise synchronization with the reference clock between slot indication signals by using the precise internal clock, used to maintain frequency and phase synchronization. In some embodiments, the UE may use every slot indication signal to check and/or adjust the synchronization of the UE clock. In some embodiments, the UE may only check and/or adjust the synchronization of the UE clock using one or more slot indication signals per radio frame. The UE may check and/or adjust the synchronization of the UE clock using any number of slot indication signals that provides the degree of synchronization required for a given process. The degree of drift of the UE clock relative to the reference time, the distance from the UE to the SC, the velocity of UE, and the particular process being executed by the UE may factor into determining how frequently to check and/or adjust the synchronization of the UE clock using one or more indication signals.

As described above, the slot indication signal is a physical layer signal. In some embodiments, other physical layer signals may be used to indicate for the synchronization between the SC and UE. The system can implement an OFDM symbol-based synchronization to improve synchronization accuracy. Each slot includes 14 OFDM symbols and by using the symbol boundary, as the synchronization signal, the deviation between the disciplining signal (i.e., the symbol boundary) and the reference clock is reduced. For example, a Time-Locked Loop (TLL) system may implement the synchronization with the reference clock of the virtual clock domain. In some embodiments, the minimum precision of the synchronization achievable when using the symbol boundary, as the synchronization signal, depends on the subcarrier spacing that is used. In some embodiments, signals encoded in a subset of the symbols of the data frame, such as a pattern of synchronization signals, may be used as the synchronization signal. For example, the PSS and/or SSS may be used as the synchronization signal.

The subcarrier spacing determines the symbol duration, and in the event that the signals get disrupted or an error occurs, and the symbol synchronization is lost, the subsequent symbol will reestablish synchronization. In such cases, the synchronization procedure may provide a minimum precision that is comparable with the symbol duration. For example, when using a subcarrier spacing of 15 kHz, the symbol duration is provided by the following equation.

$$\frac{slot duration}{number of symbols per slot} = \frac{1 ms}{14} \approx 71 μs$$

As another example, when using a subcarrier spacing of 30 kHz or 60 kHz the minimum precision is approximately 36 μs and 18 μs respectively.

For transmitting radio frames between the SC and a UE, the transmitter and receiver are synchronized in frequency and phase. In some embodiments, the radio frame is transmitted over frequencies smaller than 3 GHz. In some embodiments, the radio frame is transmitted over frequencies between 3 GHz and 6 GHz. In some embodiments, the radio frame is transmitted at frequencies larger than 6 GHz. The period of frequencies greater than or equal to 1 GHz correspond to a period of oscillation of less than or equal to 1 ns. Thus, the synchronization of the frequency and phase, used for transmitting and receiving, may be within 1 ns. In some embodiments, the synchronization in frequency and phase is used to count local time of the UE clock from the last synchronizing signal. In some embodiments, the precision of synchronization between the UE clock and the SC clock are synchronized to within 100 ns, 10 ns, or 1 ns.

In some embodiments, the timing signals may be used to continuously adjust the UE clock to enforce synchronization between the UE and the SC. In some embodiments, the periodicity of adjusting the UE clock is based on a desired accuracy associated with process instructions, as described herein, and/or a set QoS. In some embodiments, the periodicity of adjusting the UE clock based on received timing signals may vary according to a set of instructions associated with a process performed by the UE.

FIG. 7 illustrates process 700 of adjusting the UE timing system based on the timing signal received by the UE, in accordance with some embodiments. The UE determines an offset, A, between the timing signal and an internal clock flank of the UE timing system (i.e., internal clock). In the illustrated embodiment, the offset 702 between slot indication 661 and the internal clock flank 671 is determined by the UE. To determine the synchronized time of the UE, that would synchronize the UE with the virtual clock domain, the UE uses the reference time, the timing advance, and the offset, as described by the following equation:

τ_{Synchronized Time}=τ_{Reference Time}+τ_{Timing Advance}±Δ_{Timing Signal} Equation 3

In Equation 3 T Reference Time is the time of the virtual clock domain at the time of transmission, τ_{Timing Advance} is the time for a signal to travel between the SC and the UE, and Δ_{Timing Signal} is the time between the arrival of the physical layer signal at the UE and the next clock flank. The offset Δ_{Timing Signal} may also be used to by a timing feedback circuit to adjust the internal clock flank to be coincident with subsequent timing signals.

FIG. 8 illustrates a time locked loop feedback circuit 800, in accordance with some embodiments. In some embodiments, time locked loop 800 uses the time output for feedback, instead of using the phase. The Time Locked Loop maintains the phase alignment between the transmitted and received signals while providing adjustments to the clock signal. In some embodiments, timing feedback circuit functions like a PLL (Phase Locked Loop) that operates in the time domain instead of the phase domain. For example, the time locked loop includes controlled oscillator 802, real-time clock (counter) 804, time comparator 806, and loop filter 808. In some embodiments, controlled oscillator 802 generates periodic timing signals. The periodic timing signals are used by real-time counter 804 to count time and produce a time-out signal. The time-out signal is provided as feedback to time comparator 806 that compares the computed time-out with a reference time-in signal. Time comparator 806 result is filtered by loop filter 808 and provided as input to controlled oscillator 802.

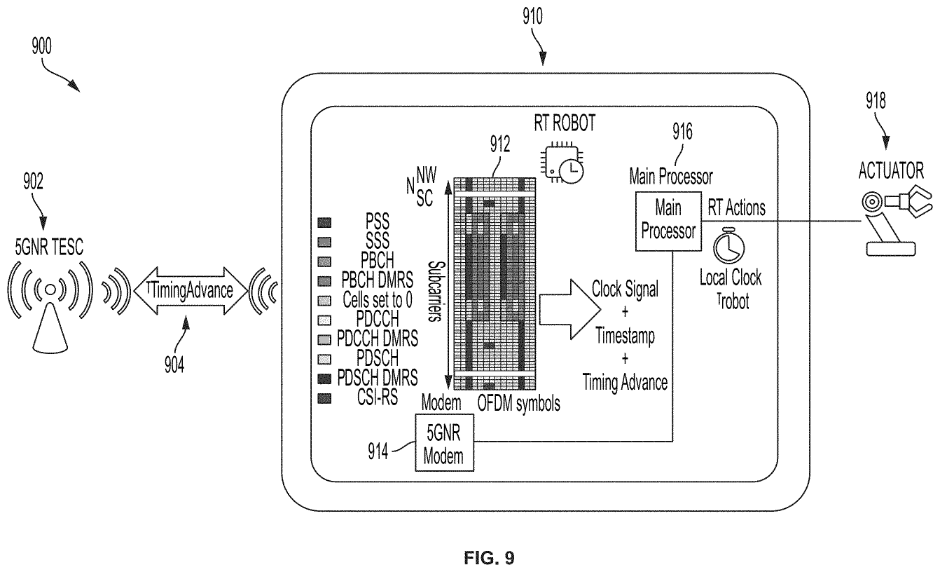

FIG. 9 illustrates an exemplary implementation of TSN network 900 including a 5G small cell and UE, in accordance with some embodiments. TSN network 900 includes a TSN-enabled small cell (TESC) 902 configured to provide 5G network connectivity to UE 910. TESC 902 transmits radio frame 912 to UE modem 914 with timing advance 904 such that the arrival of the physical layer signals, of the radio frame 912, correspond to the time encoded within the timing block of radio frame 912. The interface between modem 914 and main processor 916 includes the Clock Signal, which is network synchronized, and the Network Time in the form of a timestamp that includes the timing advance. Main processor 916 can use the Network Time to schedule the real time actions to be performed by actuator 918.

In some embodiments, modem 914 extracts PSS and SSS, from the 5GNR Frame 912, to generate the signals for synchronizing the local clock with the Network Time. This solution enables implementation of a Virtual Clock Domain or TSN network between the UE 910, the 5G SC base station 902 and a reference clock of the system. The TSN network guarantees that the clock accuracy will be better than 1.5 μs, in accordance with some embodiments described herein.

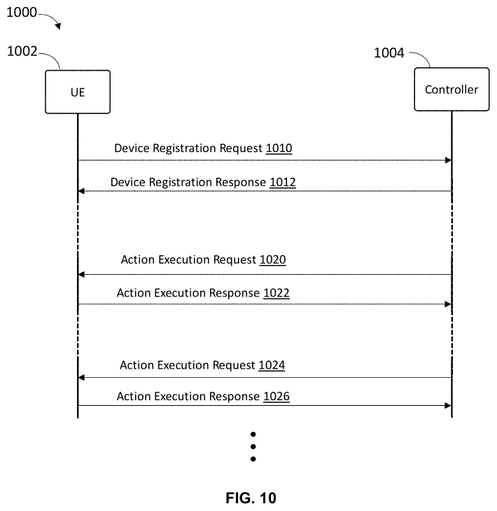

FIG. 10 illustrates an exemplary TSN registration and execution request, in accordance with some embodiments. In the embodiment illustrated in the FIG. 3, the application implements a client-server architecture. The client-server architecture includes a dedicated controller 1004 that is an industrial controller. As shown in FIG. 10, the UE 1002 may establish an application-layer communication with the controller. To establish an application layer communication, UE 1002 transmits device registration request 1010 to controller 1004 to register the UE on the system that receives instructions from the controller. Device registration request 1010 may signal a device user ID (UID) and if the device supports the 5g-radio-frame-based-synchronization (i.e., wireless TSN capable) and a synchronization accuracy. As discussed above, for some applications, the synchronization accuracy will be impacted by the numerology (i.e., subcarrier spacing). Controller 1004 responds with device registration response 1012. After the registration, controller 1004 can send, to the UE 1002, action execution requests that are time-aligned and include an execution timestamp, action ID, and any optional parameters. For example, Controller 1004 may transmit action execution request 1020 to UE 1002 specifying the time for execution of the action by UE 1002. In response, UE 1002 may respond by transmitting action execution response 1022, confirming execution of the scheduled action. Controller 1004 may transmit additional action execution requests specifying subsequent actions for execution by UE 1002. In some embodiments, controller 1004 may send action execution requests sequentially, as shown in FIG. 10. Controller 1004 transmits subsequent action execution request 1024 to UE 1002, after action execution request 1022 has been received by controller 1004. UE 1002 may respond to action execution request 1022 by transmitting action execution response 1026. Action execution response 1026 may specify that the action has been performed, or the action execution response 1026 may confirm that the scheduled action request has been received and confirm the scheduled time of execution with an upcoming timestamp. In other embodiments, controller 1004 may transmit multiple action execution requests in a non-sequential configuration.

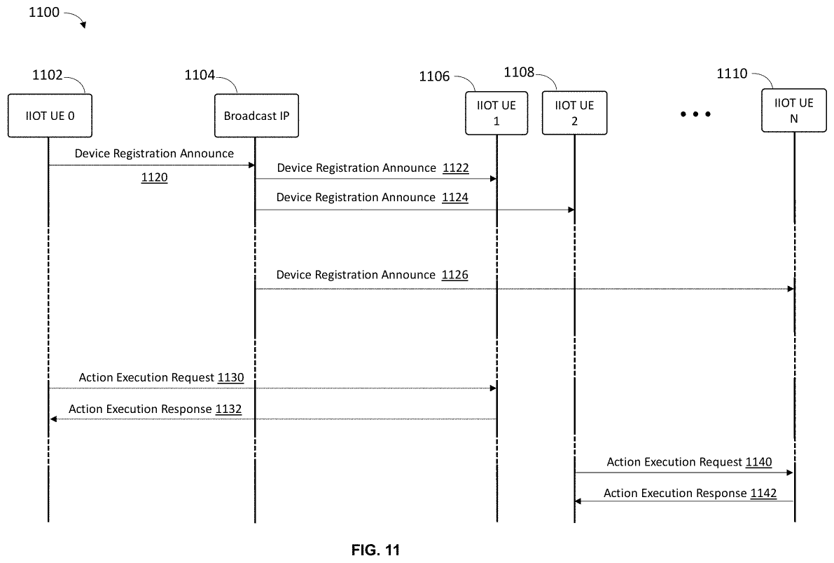

FIG. 11 illustrates an exemplary peer-to-peer TSN protocol 1100, in accordance with some embodiments. The TSN protocol may implement a network without a centralized controller using a peer-to-peer application. In the peer-to-peer application, the same architecture as illustrated in FIG. 3 may be used, but device registration and action scheduling may be executed without the use of a centralized controller. In the peer-to-peer application, the edge devices, such as multiple UEs, negotiate and agree to the actions to be performed collectively. In this way, the peer-to-peer application implements a Collaborative Robot deployment, of a Multi-Agent system, deployed in physical devices. The peers participating in the TSN protocol are capable of adapting the scheduled actions to the real-time needs or characteristics of the environment.

FIG. 11 illustrates UEs 1102, 1104, 1106, 1108 and 1110 as components of peer-to-peer network 1100. UE 1202 is illustrated performing auto-discovery and action execution processes, in accordance with some embodiments. The auto-discovery process begins by broadcasting a device identifier to broadcasting facility to register UE 1102 with the peer-to-peer network. The device identifier and capabilities of the newly deployed UE, such as an indication that the device supports 5g-radio-frame-based-synchronization and an accuracy that may be included with device registration message 1120. The broadcasting message is forwarded to the UEs of the peer-to-peer network through subsequent device registration messages 1122, 1124, and 1126 corresponding to UEs 1106, 1108, and 1110 respectively.

Following UE registration, action execution requests may be transmitted between the peers of network 1100. For example, UE 1102 may transmit action execution request 1130 including a timestamp, action ID, and optional parameters to UE 1106. UE 1106 may respond by transmitting action execution response, confirming the scheduling of the action execution request, as described herein. Additional action execution requests may be transmitted concurrently, and/or subsequently by other UEs of network 1100. For example, UE 1108 may transmit an action execution request 1140 to UE 1110, which may respond by transmitting action execution response 1142, as described herein.

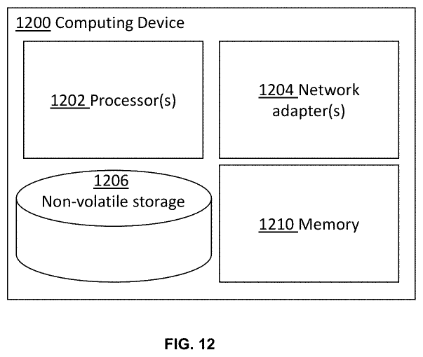

FIG. 12 illustrates one exemplary implementation of a computing device in the form of computing device 1200 that may be used in a system implementing techniques described herein, although others are possible. It should be appreciated that FIG. 12 is intended neither to be a description of necessary components for a computing device to operate as a IIOT or TSN facility, in accordance with the techniques described herein, nor a comprehensive depiction.

Computing device 1200 may include at least one processor 1202, a network adapter 1204, and a non-volatile computer-readable storage media 1206. Computing device 1200 may be, for example a desktop or laptop personal computer, a personal digital assistant, a smart mobile phone, IIOT equipment, or any other suitable computing device. Network adapter 1204 may be any suitable hardware and/or software to enable the computing device 1200 to communicate through wired and/or wireless connections with any other suitable computing device over any suitable computing network and using any suitable networking protocol, as described herein. The computing network may include switches, routers, gateways, access points, and/or other networking equipment as well as any suitable wired and/or wireless communication medium or media for exchanging data between two or more computers, including the Internet. Non-volatile computer readable storage media 1206 may be adapted to store data to be processed and/or instructions to be executed by processor 1202. Processor 1202 enables processing of data and execution of instructions. The data instructions may be stored on the computer-readable storage media 1206. The processor 1202 may control writing data to and reading data from the non-volatile computer-readable storage media 1206 and memory 1210 in any suitable manner, as the aspects of the disclosure provided herein are not limited in this respect.

The data and instructions stored on computer-readable storage media 1206 may include computer-executable instructions implementing techniques which operate according to the techniques described herein. In the example of FIG. 12, non-volatile computer-readable storage media 1206 stores computer-executable instructions implementing various facilities and storing various information as described above. Non-volatile computer-readable storage media 1206 may store an IIOT or TSN facility, in accordance with some embodiments described herein.

While not illustrated in FIG. 12, a computing device may additionally have one or more components and peripherals, including input and output devices. These devices can be used, among other things to present a user interface. Examples, of output devices that can be used to provide a user interface include printers or display screens for visual presentation of output and speakers or other sound generating devices for audible presentation of output. Example of input devices that can be used for a user interface include keyboards, and pointing devices, such as mice, touch pads, and digitizing tablets. As another example, a computing device may receive input information through speech recognition or in other audible format.

Techniques operating according to the principles described herein may be implemented in any suitable manner. The processing and decision blocks of the flowcharts above represent steps and acts that may be included in algorithms that carry out these various processes. Algorithms derived from these processes may be implemented as software integrated with and directing the operation of one or more single- or multi-purpose processors, may be implemented as functionally equivalent circuits such as a Digital Signal Processing (DSP) circuit or an Application-Specific Integrated Circuit (ASIC), or may be implemented in any other suitable manner. It should be appreciated that the flowcharts included herein do not depict the syntax or operation of any particular circuit or of any particular programming language or type of programming language. Rather, the flowcharts illustrate the functional information one skilled in the art may use to fabricate circuits or to implement computer software algorithms to perform the processing of a particular apparatus carrying out the types of techniques described herein. It should also be appreciated that, unless otherwise indicated herein, the particular sequence of steps and/or acts described in each flowchart is merely illustrative of the algorithms that may be implemented and can be varied in implementations and embodiments of the principles described herein.

Accordingly, in some embodiments, the techniques described herein may be embodied in computer-executable instructions implemented as software, including as application software, system software, firmware, middleware, embedded code, or any other suitable type of computer code. Such computer-executable instructions may be written using any of a number of suitable programming languages and/or programming or scripting tools, and also may be compiled as executable machine language code or intermediate code that is executed on a framework or virtual machine.

When techniques described herein are embodied as computer-executable instructions, these computer-executable instructions may be implemented in any suitable manner, including as a number of functional facilities, each providing one or more operations to complete execution of algorithms operating according to these techniques. A “functional facility,” however instantiated, is a structural component of a computer system that, when integrated with and executed by one or more computers, causes the one or more computers to perform a specific operational role. A functional facility may be a portion of or an entire software element. For example, a functional facility may be implemented as a function of a process, or as a discrete process, or as any other suitable unit of processing. If techniques described herein are implemented as multiple functional facilities, each functional facility may be implemented in its own way; all need not be implemented the same way. Additionally, these functional facilities may be executed in parallel and/or serially, as appropriate, and may pass information between one another using a shared memory on the computer(s) on which they are executing, using a message passing protocol, or in any other suitable way.

Generally, functional facilities include routines, programs, objects, components, data structures, etc. that perform particular tasks or implement particular abstract data types. Typically, the functionality of the functional facilities may be combined or distributed as desired in the systems in which they operate. In some implementations, one or more functional facilities carrying out techniques herein may together form a complete software package. These functional facilities may, in alternative embodiments, be adapted to interact with other, unrelated functional facilities and/or processes, to implement a software program application.

Some exemplary functional facilities have been described herein for carrying out one or more tasks. It should be appreciated, though, that the functional facilities and division of tasks described is merely illustrative of the type of functional facilities that may implement using the exemplary techniques described herein, and that embodiments are not limited to being implemented in any specific number, division, or type of functional facilities. In some implementations, all functionalities may be implemented in a single functional facility. It should also be appreciated that, in some implementations, some of the functional facilities described herein may be implemented together with or separately from others (i.e., as a single unit or separate units), or some of these functional facilities may not be implemented.

Computer-executable instructions implementing the techniques described herein (when implemented as one or more functional facilities or in any other manner) may, in some embodiments, be encoded on one or more computer-readable media to provide functionality to the media. Computer-readable media include magnetic media such as a hard disk drive, optical media such as a Compact Disk (CD) or a Digital Versatile Disk (DVD), a persistent or non-persistent solid-state memory (e.g., Flash memory, Magnetic RAM, etc.), or any other suitable storage media. Such a computer-readable medium may be implemented in any suitable manner. As used herein, “computer-readable media” (also called “computer-readable storage media”) refers to tangible storage media. Tangible storage media are non-transitory and have at least one physical, structural component. In a “computer-readable medium,” as used herein, at least one physical, structural component has at least one physical property that may be altered in some way during a process of creating the medium with embedded information, a process of recording information thereon, or any other process of encoding the medium with information. For example, a magnetization state of a portion of a physical structure of a computer-readable medium may be altered during a recording process.

Further, some techniques described above comprise acts of storing information (e.g., data and/or instructions) in certain ways for use by these techniques. In some implementations of these techniques—such as implementations where the techniques are implemented as computer-executable instructions—the information may be encoded on a computer-readable storage media. Where specific structures are described herein as advantageous formats in which to store this information, these structures may be used to impart a physical organization of the information when encoded on the storage medium. These advantageous structures may then provide functionality to the storage medium by affecting operations of one or more processors interacting with the information; for example, by increasing the efficiency of computer operations performed by the processor(s).

In some, but not all, implementations in which the techniques may be embodied as computer-executable instructions, these instructions may be executed on one or more suitable computing device(s) operating in any suitable computer system, or one or more computing devices (or one or more processors of one or more computing devices) may be programmed to execute the computer-executable instructions. A computing device or processor may be programmed to execute instructions when the instructions are stored in a manner accessible to the computing device or processor, such as in a data store (e.g., an on-chip cache or instruction register, a computer-readable storage medium accessible via a bus, a computer-readable storage medium accessible via one or more networks and accessible by the device/processor, etc.). Functional facilities comprising these computer-executable instructions may be integrated with and direct the operation of a single multi-purpose programmable digital computing device, a coordinated system of two or more multi-purpose computing device sharing processing power and jointly carrying out the techniques described herein, a single computing device or coordinated system of computing device (co-located or geographically distributed) dedicated to executing the techniques described herein, one or more Field-Programmable Gate Arrays (FPGAs) for carrying out the techniques described herein, or any other suitable system.

Embodiments have been described where the techniques are implemented in circuitry and/or computer-executable instructions. It should be appreciated that some embodiments may be in the form of a method, of which at least one example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

Various aspects of the embodiments described above may be used alone, in combination, or in a variety of arrangements not specifically discussed in the embodiments described in the foregoing and is therefore not limited in its application to the details and arrangement of components set forth in the foregoing description or illustrated in the drawings. For example, aspects described in one embodiment may be combined in any manner with aspects described in other embodiments.

The phrase “and/or,” as used herein in the specification and in the claims, should be understood to mean “either or both,” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B,” when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

The indefinite articles “a” and “an,” as used herein in the specification and in the claims, unless clearly indicated to the contrary, should be understood to mean “at least one.”

As used herein in the specification and in the claims, the phrase, “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently, “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, at least one, optionally including more than one, B (and optionally including other elements); etc.

Use of ordinal terms such as “first,” “second,” “third,” etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

Also, the phraseology and terminology used herein is for the purpose of description and should not be regarded as limiting. The use of “including,” “comprising,” “having,” “containing,” “involving,” and variations thereof herein, is meant to encompass the items listed thereafter and equivalents thereof as well as additional items.

All definitions, as defined and used herein, should be understood to control over dictionary definitions, definitions in documents incorporated by reference, and/or ordinary meanings of the defined terms.

The word “exemplary” is used herein to mean serving as an example, instance, or illustration. Any embodiment, implementation, process, feature, etc. described herein as exemplary should therefore be understood to be an illustrative example and should not be understood to be a preferred or advantageous example unless otherwise indicated.

Having thus described several aspects of at least one embodiment, it is to be appreciated that various alterations, modifications, and improvements will readily occur to those skilled in the art. Such alterations, modifications, and improvements are intended to be part of this disclosure and are intended to be within the spirit and scope of the principles described herein. Accordingly, the foregoing description and drawings are by way of example only.

Various aspects are described in this disclosure, which include, but are not limited to, the following aspects:

1. A computerized method to provide a Time-Sensitive Networking (TSN) synchronization protocol over a wireless channel of a cellular network, the method comprising performing, by a cellular network device: receiving, by the network device, timing information from a cellular network node, wherein: the cellular network node is in wired communication with the network device; and the timing information is associated with a Network Clock Reference and a transmission time to the network device in accordance with a wired synchronization protocol; determining, by the network device, a timing adjustment based on the timing information; and adjusting, based on the timing adjustment, timing signals that are transmitted by the network device to a user device in cellular communication with the cellular network node through the network device, wherein the timing signals is used to adjust a timing system of the user device in accordance with the TSN synchronization protocol.

2. The computerized method of aspect 1, wherein the TSN synchronization protocol is a wireless synchronization protocol, and the wireless synchronization protocol comprises: transmitting, by the network device, downlink information of a radio frame, wherein the transmitting the downlink information comprises transmitting a pattern of reference synchronization signals as the timing signals to the user device; receiving, by the network device, uplink information of the radio frame, wherein the uplink information comprises response information corresponding to a time of arrival of the downlink information at the user device; and determining, by the network device, delay information associated with a travel time for the radio frame to wirelessly travel from the network device to the user device, wherein determining the delay information comprises comparing a first time associated with the network device transmitting the downlink information, to a second time associated with the network device receiving the uplink information.

3. The computerized method of aspect 2, wherein the receiving, by the network device, the uplink information further comprises using a Random-Access procedure between the network device and the user device, and the determining the delay information further comprises determining a timing advance.

4. The computerized method of aspect 2, wherein: the radio frame comprises a plurality of subframes, wherein each of the plurality of subframes comprises a plurality of slots, wherein each of the plurality of slots comprises a plurality of symbols; and the transmitting the pattern of reference synchronization signals further comprises transmitting the pattern of reference synchronization signals as a sub-set of the plurality of symbols.

5. The computerized method of aspect 4, wherein the determining the timing adjustment further comprises: determining a synchronized time based on the timing information and the delay information; determining a target arrival time for a portion of the radio frame based on the synchronized time; and determining the timing adjustment based on the target arrival time, the timing information, and the delay information such that, when transmitted, the portion of the radio frame arrives at the user device at the target arrival time.

6. The computerized method of aspect 5, wherein the portion of the radio frame is a first slot of a first subframe of the radio frame, and the target arrival time that the radio frame arrives at the user device is at the start of a synchronized clock interval.

7. The computerized method of any of aspects 5-6, wherein the TSN synchronization protocol supports TSN in accordance with IEEE 802.1AS standard, the TSN synchronization protocol further comprising transmitting, by the network device, the synchronized time such that when the synchronized time arrives at the user device, the synchronized time is synchronized to within a predetermined threshold of a reference time.

8. The computerized method of aspect 7, wherein the predetermined threshold is within 1 nanosecond of the reference time, within 1 microsecond of the reference time, or some combination thereof.

9. The computerized method of aspect 7, wherein the predetermined threshold is within 250 nanoseconds of the reference time in dispersive channels with time-variant conditions.

10. The computerized method of any of aspects 2-9, wherein transmitting the pattern of reference synchronization signals further comprises transmitting a radio frame using subcarrier bandwidths from 15 kHz to 240 kHz.

11. The computerized method of any of aspects 1-10, wherein the receiving timing information from the cellular network comprises receiving a reference time, residence time, and link delay from the reference clock to the network node based on a generic Precision Time Protocol (g-PTP) of the cellular network.

12. The computerized method of any of aspects 1-11, wherein the network device is a base station.

13. The computerized method of aspect 12, wherein the base station is a gNodeB and the cellular network is a 5G network.

14. An apparatus configured to provide a TSN synchronization protocol over a wireless channel of a cellular network, the apparatus comprising a processor in communication with memory and a set of additional processing resources, the processor being configured to execute instructions stored in the memory that cause the processor to: receive, by the network device, timing information from a cellular network node, wherein: the cellular network node is in wired communication with the network device; and the timing information is associated with a Network Clock Reference and a transmission time to the network device in accordance with a wired synchronization protocol; determine, by the network device, a timing adjustment based on the timing information; and adjust, based on the timing adjustment, timing signals that is transmitted by the network device to a user device in cellular communication with the cellular network node through the network device, wherein the timing signals is used to adjust a timing system of the user device in accordance with the TSN synchronization protocol.

15. The apparatus of aspect 14, wherein the TSN synchronization protocol is a wireless synchronization protocol, and wherein the instructions are further configured in accordance with the TSN synchronization protocol to cause the apparatus to: transmit, by the network device, downlink information of a radio frame, wherein the transmitting the downlink information comprises transmitting a pattern of reference synchronization signals as the timing signals to the user device; receive, by the network device, uplink information of the radio frame, wherein the uplink information comprises response information corresponding to a time of arrival of the downlink information at the user device; and determine, by the network device, delay information associated with a travel time for the radio frame to wirelessly travel from the network device to the user device, wherein determining the delay information comprises comparing a first time associated with the network device transmitting the downlink information, to a second time associated with the network device receiving the uplink information.

16. The apparatus of aspect 15, wherein the instructions are configured such that the radio frame comprises a plurality of subframes, wherein each of the plurality of subframes comprises a plurality of slots, wherein each of the plurality of slots comprises a plurality of symbols; and the instructions are further configured to cause the apparatus to transmit the pattern of reference synchronization signals further comprises transmitting the pattern of reference synchronization signals as a sub-set of the plurality of symbols.

17. The apparatus of aspect 16, the instructions to cause the apparatus to determine the timing adjustment are further configured to: determine a synchronized time based on the timing information, and the delay information; determine a target arrival time for a portion of the radio frame based on the synchronized time; and determine the timing adjustment based on the target arrival time, the timing information, and the delay information such that, when transmitted, the portion of the radio frame arrives at the user device at the target arrival time.

18. The apparatus of aspect 15-17, wherein the instructions are further configured to execute actions sent from the cellular network that are time-synchronized with at least one user device action through a communication protocol that specifies an action type to be executed and the time when the action shall be executed.

19. At least one non-transitory computer-readable storage medium encoded with a plurality of computer-executable instructions that, when executed, perform a method to provide a TSN synchronization protocol over a wireless channel of a cellular network, the method comprising: receiving, by the network device, timing information from a cellular network node, wherein: the cellular network node is in wired communication with the network device; and the timing information is associated with a Network Clock Reference and a transmission time to the network device in accordance with a wired synchronization protocol; determining, by the network device, a timing adjustment based on the timing information; and adjusting, based on the timing adjustment, timing signals that are transmitted by the network device to a user device in cellular communication with the cellular network node through the network device, wherein the timing signals is used to adjust a timing system of the user device in accordance with the TSN synchronization protocol.

20. The at least one non-transitory computer-readable storage medium of aspect 19, wherein the synchronization protocol is a wireless synchronization protocol, and the wireless synchronization protocol comprises: transmitting, by the network device, downlink information of a radio frame, wherein the transmitting the downlink information comprises transmitting a pattern of reference synchronization signals as the timing signals to the user device; receiving, by the network device, uplink information of the radio frame, wherein the uplink information comprises response information corresponding to a time of arrival of the downlink information at the user device; and determining, by the network device, delay information associated with a travel time for the radio frame to wirelessly travel from the network device to the user device, wherein determining the delay information comprises comparing a first time associated with the network device transmitting the downlink information, to a second time associated with the network device receiving the uplink information.

21. The at least one non-transitory computer-readable storage medium of aspect 20, wherein the determining the timing adjustment further comprises: determining a synchronized time based on the timing information and the delay information; determining a target arrival time for a portion of the radio frame based on the synchronized time; and determining the timing adjustment based on the target arrival time, the timing information, and the delay information such that, when transmitted, the portion of the radio frame arrives at the user device at the target arrival time.

22. An apparatus configured to receive a synchronization protocol over a wireless channel of a cellular network, the apparatus comprising a processor in communication with memory and a set of additional processing resources, the processor being configured to execute instructions stored in the memory that cause the processor to: receive, by a user device, timing information from a network device, wherein: receiving, by the user device, comprises receiving downlink information of a radio frame, wherein the downlink information comprises frequency and phase synchronization signals configured as timing signals to the user device; the user device extracts, from a 5GNR Radio Resource Control System Information Block 9, a Timing Advance MAC control element and a time reference of the network device to adjust and discipline using the frequency and phase synchronization signals; the user device extracts a physical layer signal from a Slot Indication signal associated with the radio frame and/or a Symbol Boundary signal to adjust and discipline an internal clock of the user device to meet a time accuracy within a Virtual Clock Domain comprising TSN enabled user devices, network devices, network node and TSN controller.

23. The apparatus of aspect 22, wherein the instructions further comprise informing the network device about support of the synchronization protocol and an achievable time accuracy using the instructions described in aspect 17.

24. The apparatus of aspect 22, that includes a clock disciplining subsystem to use the physical signals of Slot Indication signals and/or Symbol Boundary signals to discipline the internal clock that translates timing information into a computer-executable instruction that comprises the messages associated with the instructions described in aspect 17.

1. A computerized method to provide a Time-Sensitive Networking (TSN) synchronization protocol over a wireless channel of a cellular network, the method comprising performing, by a cellular network device:
receiving, by the network device, timing information from a cellular network node, wherein:
the cellular network node is in wired communication with the network device; and
the timing information is associated with a Network Clock Reference and a transmission time to the network device in accordance with a wired synchronization protocol;
determining, by the network device, a timing adjustment based on the timing information; and
adjusting, based on the timing adjustment, timing signals that are transmitted by the network device to a user device in cellular communication with the cellular network node through the network device, wherein the timing signals is used to adjust a timing system of the user device in accordance with the TSN synchronization protocol.

2. The computerized method of claim 1, wherein the TSN synchronization protocol is a wireless synchronization protocol, and the wireless synchronization protocol comprises:
transmitting, by the network device, downlink information of a radio frame, wherein the transmitting the downlink information comprises transmitting a pattern of reference synchronization signals as the timing signals to the user device;
receiving, by the network device, uplink information of the radio frame, wherein the uplink information comprises response information corresponding to a time of arrival of the downlink information at the user device; and
determining, by the network device, delay information associated with a travel time for the radio frame to wirelessly travel from the network device to the user device, wherein determining the delay information comprises comparing a first time associated with the network device transmitting the downlink information, to a second time associated with the network device receiving the uplink information.

3. The computerized method of claim 2, wherein the receiving, by the network device, the uplink information further comprises using a Random-Access procedure between the network device and the user device, and the determining the delay information further comprises determining a timing advance.

4. The computerized method of claim 2, wherein:
the radio frame comprises a plurality of subframes, wherein each of the plurality of subframes comprises a plurality of slots, wherein each of the plurality of slots comprises a plurality of symbols; and
the transmitting the pattern of reference synchronization signals further comprises transmitting the pattern of reference synchronization signals as a sub-set of the plurality of symbols.

5. The computerized method of claim 4, wherein the determining the timing adjustment further comprises:
determining a synchronized time based on the timing information and the delay information;
determining a target arrival time for a portion of the radio frame based on the synchronized time; and
determining the timing adjustment based on the target arrival time, the timing information, and the delay information such that, when transmitted, the portion of the radio frame arrives at the user device at the target arrival time.

6. The computerized method of claim 5, wherein the portion of the radio frame is a first slot of a first subframe of the radio frame, and the target arrival time that the radio frame arrives at the user device is at the start of a synchronized clock interval.

7. The computerized method of claim 5, wherein the TSN synchronization protocol supports TSN in accordance with IEEE 802.1AS standard, the TSN synchronization protocol further comprising transmitting, by the network device, the synchronized time such that when the synchronized time arrives at the user device, the synchronized time is synchronized to within a predetermined threshold of a reference time.

8. The computerized method of claim 7, wherein the predetermined threshold is within 1 nanosecond of the reference time, within 1 microsecond of the reference time, or some combination thereof.

9. The computerized method of claim 7, wherein the predetermined threshold is within 250 nanoseconds of the reference time in dispersive channels with time-variant conditions.

10. The computerized method of claim 2, wherein transmitting the pattern of reference synchronization signals further comprises transmitting a radio frame using subcarrier bandwidths from 15 kHz to 240 kHz.

11. The computerized method of claim 1, wherein the receiving timing information from the cellular network comprises receiving a reference time, residence time, and link delay from the reference clock to the network node based on a generic Precision Time Protocol (g-PTP) of the cellular network.

12. The computerized method of claim 1, wherein the network device is a base station.

13. The computerized method of claim 12, wherein the base station is a gNodeB and the cellular network is a 5G network.

14. An apparatus configured to provide a TSN synchronization protocol over a wireless channel of a cellular network, the apparatus comprising a processor in communication with memory and a set of additional processing resources, the processor being configured to execute instructions stored in the memory that cause the processor to:
receive, by the network device, timing information from a cellular network node, wherein:
the cellular network node is in wired communication with the network device; and
the timing information is associated with a Network Clock Reference and a transmission time to the network device in accordance with a wired synchronization protocol;
determine, by the network device, a timing adjustment based on the timing information; and
adjust, based on the timing adjustment, timing signals that is transmitted by the network device to a user device in cellular communication with the cellular network node through the network device, wherein the timing signals is used to adjust a timing system of the user device in accordance with the TSN synchronization protocol.

15. The apparatus of claim 14, wherein the TSN synchronization protocol is a wireless synchronization protocol, and wherein the instructions are further configured in accordance with the TSN synchronization protocol to cause the apparatus to:
transmit, by the network device, downlink information of a radio frame, wherein the transmitting the downlink information comprises transmitting a pattern of reference synchronization signals as the timing signals to the user device;
receive, by the network device, uplink information of the radio frame, wherein the uplink information comprises response information corresponding to a time of arrival of the downlink information at the user device; and
determine, by the network device, delay information associated with a travel time for the radio frame to wirelessly travel from the network device to the user device, wherein determining the delay information comprises comparing a first time associated with the network device transmitting the downlink information, to a second time associated with the network device receiving the uplink information.

16. The apparatus of claim 15, wherein the instructions are configured such that the radio frame comprises a plurality of subframes, wherein each of the plurality of subframes comprises a plurality of slots, wherein each of the plurality of slots comprises a plurality of symbols; and
the instructions are further configured to cause the apparatus to transmit the pattern of reference synchronization signals further comprises transmitting the pattern of reference synchronization signals as a sub-set of the plurality of symbols.

17. The apparatus of claim 16, the instructions to cause the apparatus to determine the timing adjustment are further configured to:
determine a synchronized time based on the timing information, and the delay information;
determine a target arrival time for a portion of the radio frame based on the synchronized time; and
determine the timing adjustment based on the target arrival time, the timing information, and the delay information such that, when transmitted, the portion of the radio frame arrives at the user device at the target arrival time.

18. The apparatus of claim 15, wherein the instructions are further configured to execute actions sent from the cellular network that are time-synchronized with at least one user device action through a communication protocol that specifies an action type to be executed and the time when the action shall be executed.

19. At least one non-transitory computer-readable storage medium encoded with a plurality of computer-executable instructions that, when executed, perform a method to provide a TSN synchronization protocol over a wireless channel of a cellular network, the method comprising:
receiving, by the network device, timing information from a cellular network node, wherein:
the cellular network node is in wired communication with the network device; and
the timing information is associated with a Network Clock Reference and a transmission time to the network device in accordance with a wired synchronization protocol;
determining, by the network device, a timing adjustment based on the timing information; and
adjusting, based on the timing adjustment, timing signals that are transmitted by the network device to a user device in cellular communication with the cellular network node through the network device, wherein the timing signals is used to adjust a timing system of the user device in accordance with the TSN synchronization protocol.

20. The at least one non-transitory computer-readable storage medium of claim 19, wherein the synchronization protocol is a wireless synchronization protocol, and the wireless synchronization protocol comprises:
transmitting, by the network device, downlink information of a radio frame, wherein the transmitting the downlink information comprises transmitting a pattern of reference synchronization signals as the timing signals to the user device;
receiving, by the network device, uplink information of the radio frame, wherein the uplink information comprises response information corresponding to a time of arrival of the downlink information at the user device; and
determining, by the network device, delay information associated with a travel time for the radio frame to wirelessly travel from the network device to the user device, wherein determining the delay information comprises comparing a first time associated with the network device transmitting the downlink information, to a second time associated with the network device receiving the uplink information.

21. The at least one non-transitory computer-readable storage medium of claim 20, wherein the determining the timing adjustment further comprises:
determining a synchronized time based on the timing information and the delay information;
determining a target arrival time for a portion of the radio frame based on the synchronized time; and
determining the timing adjustment based on the target arrival time, the timing information, and the delay information such that, when transmitted, the portion of the radio frame arrives at the user device at the target arrival time.
